(19) United States
(12) Patent Application Publication
(10) Pub. No.: US 2026/0267575 A1
(43) Pub. Date: Sep. 10, 2026

(54) INFORMATION MANAGEMENT APPARATUS, INFORMATION MANAGEMENT METHOD, AND RECORDING MEDIUM

(71) Applicants: Daisuke YAMAMOTO, Tokyo (JP); Keisuke TERASAKI, Kanagawa (JP)

(72) Inventors: Daisuke YAMAMOTO, Tokyo (JP); Keisuke TERASAKI, Kanagawa (JP)

(21) Appl. No.: 18/873,739

(22) PCT Filed: May 30, 2023
(86) PCT No.: PCT/IB2023/055499

§ 371 Date: Dec. 11, 2024

(30) Foreign Application Priority Data
Jun. 15, 2022 (JP) 2022-096211
Mar. 24, 2023 (JP) 2023-048365

(51) Int. Cl. G06F 3/12

(52) U.S. Cl. CPC G06F 3/1232; G06F 3/123; G06F 3/1273; G06F 3/1288

(57) ABSTRACT

An information management apparatus for storing information on an application used in a user device includes an acquisition unit and an identifying unit. The acquisition unit acquires migration information related to a first application used in a first user device. The identifying unit identifies a second application based on the acquired migration information, first function information related to a first function of the first user device, and second function information related to a second function of a second user device.

### TECHNICAL FIELD

Embodiments of the present disclosure relate to an information management apparatus, a method for managing information, and a recording medium storing a program for causing a processor to perform the method for managing information.

### BACKGROUND ART

There is a license management method that enables an application on an information processing apparatus that is permitted to execute the application.

For example, there is a technique relating to a contract management server that manages a usage of an application on an image forming apparatus. The usage of an application is managed by a product information management unit based on information managed by a license management unit. According to the technique, when the image forming apparatus is replaced with another apparatus (succeeding apparatus) after the start of the contract, the contract management server can issue an updated continuous charging license to the succeeding apparatus (see, for example, PTL 1).

### CITATION LIST

### Patent Literature

[PTL 1]

[Patent Document 1] Japanese Unexamined Patent Application Publication No. 2017-83982

### SUMMARY OF INVENTION

### Technical Problem

The availability of an application depends on differences between a function of a user device before the replacement (an example of a first user device) and a function of a user device after the replacement (an example of a second user device), which is not fully considered in the related art.

### Solution to Problem

In one aspect, an information management apparatus for storing information on an application used in a user device includes an acquisition unit and an identifying unit. The acquisition unit acquires migration information related to a first application used in a first user device. The identifying unit identifies a second application based on the acquired migration information, first function information related to a first function of the first user device, and second function information related to a second function of a second user device.

Another aspect concerns an information management method executed by an information management apparatus that stores information on an application used in a user device. The method includes acquiring migration information related to a first application used in a first user device, and identifying a second application based on the acquired migration information, first function information related to a first function of the first user device, and second function information related to a second function of a second user device.

Another aspect concerns a recording medium storing a plurality of program codes which, when executed by one or more processors, causes an information management apparatus that stores information on an application used in a user device to perform the method described above.

### Advantageous Effects of Invention

According to the embodiments of the present disclosure, the information management apparatus can determine an available application in accordance with a difference between a function of a first user device and a function of a second user device.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a conceptual diagram illustrating an example of management of history information of a client.

FIG. 2 is a diagram illustrating an example of an overall configuration of an information processing system.

FIG. 3 is a block diagram illustrating an example of a hardware configuration common to an information management apparatus and an application distribution server.

FIG. 4 is a block diagram illustrating an example of a hardware configuration of a communication terminal.

FIG. 5 is a block diagram illustrating an example of a hardware configuration of a user device.

FIG. 6 is a block diagram illustrating a functional configuration of the information processing system according to an embodiment of the present disclosure.

FIG. 7 is a conceptual diagram illustrating an example of a user information management table.

FIG. 8 is a conceptual diagram illustrating an example of a device information management table.

FIG. 9 is a conceptual diagram illustrating an example of a license information management table.

FIG. 10 is a conceptual diagram illustrating an example of a migration information management table.

FIG. 11 is a conceptual diagram illustrating an example of an application-function correspondence management table.

FIG. 12 is a conceptual diagram illustrating an example of a substitute application management table.

FIG. 13 is a conceptual diagram illustrating an example of a recommended condition management table.

FIG. 14 is a conceptual diagram illustrating an example of an introduced item management table.

FIG. 15 is a conceptual diagram illustrating an example of a usage history management table.

FIG. 16 is a conceptual diagram illustrating another example of the usage history management table.

FIG. 17 is a sequence diagram illustrating a user authentication process according to the embodiment.

FIG. 18 is an example of a display screen for user authentication, displayed on the communication terminal.

FIG. 19 is a sequence diagram illustrating a user device registration process according to the embodiment.

FIG. 20 is an example of a display screen for device registration, displayed on the user device.

FIG. 21 is a sequence diagram illustrating a process including determining an application to be migrated, according to the embodiment.

FIG. 22 is an example of a screen display for selecting a device to be substituted with another device, displayed on the user device.

FIG. 23 is an example of a display screen for selecting a replaced device or an added device, displayed on the user device.

FIG. 24 is an example of a display screen for confirming migration information displayed on the user device.

FIG. 25 is a flowchart illustrating a migrated application determination process according to the embodiment.

FIG. 26 is a sequence diagram illustrating a process including determining a substitute application according to the embodiment.

FIG. 27A is a flowchart illustrating details of determining the substitute application according to the embodiment.

FIG. 27B is a flowchart illustrating details of determining a recommended application according to the embodiment.

FIG. 28 is a flowchart illustrating details of determining the recommended application according to the embodiment.

FIG. 29 is a sequence diagram illustrating a process of selecting the substitute application and determining whether setting information is migratable, according to the embodiment.

FIG. 30 is an example of a display screen for selecting a substitute (recommended) application, displayed on the user device.

FIG. 31 is an example of a display screen for a link information notification, displayed on the user device.

FIG. 32 is an example of a display screen for a substitute application notification, displayed on the communication terminal.

FIG. 33 is a flowchart illustrating a process of determining whether setting information is migratable according to the embodiment.

FIG. 34 is an example of a display screen for notification of application determination result, displayed on the communication terminal.

FIG. 35 is another example of the display screen for notification of application determination result, displayed on the communication terminal.

FIG. 36 is another example of the display screen for notification of application determination result, displayed on the communication terminal.

FIG. 37 is a sequence diagram illustrating a process using a user device of another type according to the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Client History Information Management

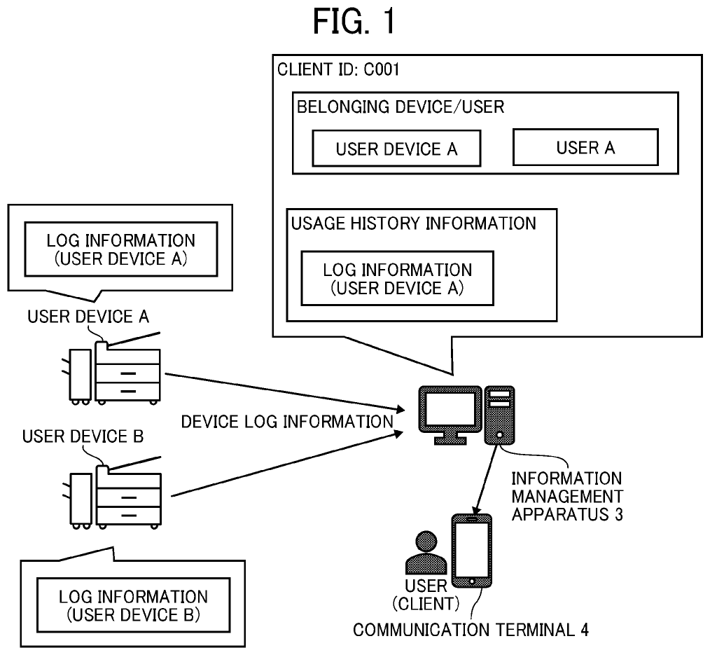

First, management of client history information in the present embodiment will be described. FIG. 1 is a conceptual diagram illustrating management of client history information. As illustrated in FIG. 1, an information management apparatus 3 manages, for each client identification information (also referred to as client ID), a user device (user device A) and a user (user A) belonging to a client. The information management apparatus 3 collects log information from each user device and associates the log information with the client ID to which the user device belongs, thereby managing the log information as usage history information. Thereafter, the information management apparatus 3 determines an item to be introduced (introduced item) based on the usage history information and recommends the introduction of the determined item to the client. For example, the information management apparatus 3 transmits, as a recommendation notification, recommendation information indicating the recommended item to be introduced (installed) to a desired destination so that an administrative user (device administrator) who manages the user device 5 can check the recommendation information. Then, the information management apparatus 3 checks whether the recommended item has been installed based on the recommendation information. Thereafter, the information management apparatus 3 manages the client ID and the installed item in association with each other.

### Overall Configuration of Information Processing System

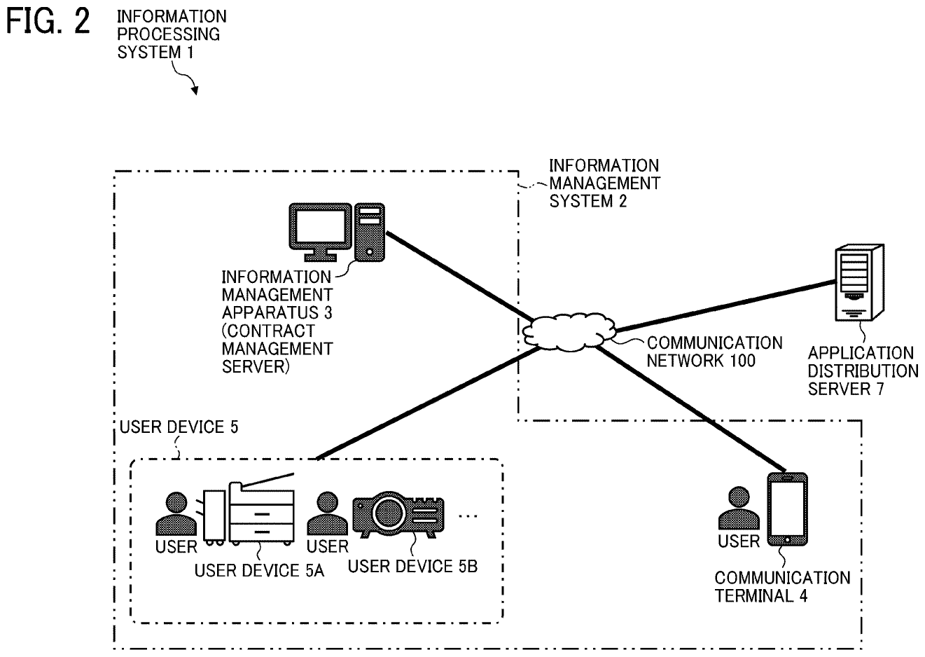

FIG. 2 is a block diagram illustrating an example of a functional configuration of an information processing system according to the present embodiment. As illustrated in FIG. 2, an information processing system 1 includes the information management apparatus 3, a communication terminal 4, user devices 5A and 5B (collectively “user devices 5”), and an application distribution server 7. In the information processing system 1, the information management apparatus 3 and the user devices 5 are components of an information management system 2. In the information processing system 1, the information management apparatus 3, the communication terminal 4, the user devices 5, and the application distribution server 7 are connected to each other via a communication network 100. When the information management apparatus 3 communicates with each of the communication terminal 4 and the user devices 5 via the communication network 100, the communication may be performed via a firewall inside the communication network 100.

The communication network 100 is a communication network through which an unspecified number of communications are established, and is implemented by the Internet, an intranet, or a local area network (LAN), for example. The communication network 100 may be a wired communication network or a wireless communication network in compliance with, for example, the fourth generation (4G), the fifth generation (5G), Worldwide Interoperability for Microwave Access (WiMAX), or Long Term Evolution (LTE).

### Information Management Apparatus

The information management apparatus 3 included in the information processing system 1 is an information processing apparatus (computer system) that manages information related to an application used by the user device 5. The information management apparatus 3 is implemented by one or more information processing apparatuses (computer systems) installed with a general server operating system (OS) and the like, and manages history information related to an item to be introduced, including an application (hereinafter may be referred to as an “app”) recommended to be used. The history information is, for example, usage history information indicating a usage history when a function of the user device 5 is used. The information management apparatus 3 performs recommendation determination to be described later based on the history information. The information management apparatus 3 may have the function of managing the installation of an application. The information management apparatus 3 has a communication application, stored in a storage unit, for performing communication with other devices and communication terminals. The information management apparatus 3 may manage the usage history of the item to be introduced, in cooperation with another management server that manages the usage history. That is, the information management apparatus 3 may separately manage history information (log information) as a usage history and information for recommending the introduction of an item.

The information management apparatus 3 may be a generally used personal computer (PC) or portable laptop computer; or a communication terminal having a communication function such as a mobile phone, a smartphone, or a tablet terminal. Alternatively, the information management apparatus 3 may be a communication device or a communication terminal on which software such as browser software operates. Yet alternatively, the information management apparatus 3 may be implemented by a plurality of computers.

The information management apparatus 3 may transmit, as a notification, data (information) to the communication terminal 4 or the user device 5, which will be described later, by push notification (transmission). Examples of the notification include a notification of application determination result as a result of the recommendation determination. In this case, the information management apparatus 3 can perform the notification (transmission) of data (information) by push notification using, for example, Firebase Cloud Messaging (FCM) which is an example of a push notification server.

### Communication Terminal

The communication terminal 4 is used by a user who uses or manages a user device 5 described later. The communication terminal 4 is implemented by an information processing apparatus (computer system) for communication, installed with a general-purpose operating system (OS). The communication terminal 4 receives and displays the notification of application determination result transmitted from the information management apparatus 3. The communication terminals 4 has a communication application, stored in a storage unit, for performing communication with other devices and applications that provide a generally used external service, and other communication terminals 4.

The communication terminal 4 may be a generally used PC or portable laptop computer; or a communication terminal having a communication function such a mobile phone, a smartphone, a tablet terminal, or a wearable terminal (of sunglass type or wristwatch type, for example). Alternatively, the communication terminal 4 may be a communication device or a communication terminal on which software, such as browser software and various application software, operates.

### User Device

The user device 5 is managed in association with the client ID by the information management apparatus 3. The user device 5 is implemented by, for example, an information processing apparatus (computer system) for performing communication, installed with a general OS and the like, and is a device (apparatus) that provides history information on an item to be introduced, for example, a recommended application. When a function of the user device 5 is used, the user device 5 stores log information as an example of a usage history and uploads the log information to the information management apparatus 3. Further, the user device 5 receives and displays the notification of application determination result transmitted from the information management apparatus 3. Further, the user device 5 introduces (installs) and uses the substitute (recommended) item (e.g., application). As illustrated in FIG. 1, the user device 5A is a multifunction peripheral (MFP) that is an example of an image forming apparatus. The user device 5B is a projector that projects a desired image, video, or the like on a screen. In the present embodiment, when not particular specified, the user device 5A or 5B is simply referred to as the “user device 5.” In addition, examples of the user device 5 include a scanner, a facsimile machine, an electronic whiteboard, a PC, a smartphone, and an interactive voice-controlled device (a smart speaker or an artificial intelligence (AI) speaker). In addition, the user device 5 has a communication application, stored in a storage unit, for performing communication with other devices and applications that provide a generally used external service, and other devices, and communication terminals via the communication network 100.

The user device 5 may be implemented by a single computer such as a desktop PC or a portable laptop computer that is generally used.

### Application Distribution Server

The application distribution server 7 is an information processing apparatus (computer system) that provides an application, a service, and the like to the user device 5 or the user. The application distribution server 7 is implemented by one or more information processing apparatuses (computer systems), installed with a general-purpose server operating system (OS), for example. In addition, the application distribution server 7 stores, in a predetermined storage area, and manages various applications distributed or introduced to the user device 5. The application distribution server 7 can further perform authentication for a predetermined processing request from the user device 5 and execute predetermined processing. As the predetermined processing, for example, the application distribution server 7 provides the user device 5 with application data or an application function, or provides the user device 5 or the user with a service. The addition, the application distribution server 7 has a communication application, stored in a storage unit, for performing communication with other devices and communication terminals.

The application distribution server 7 may be implemented by a single computer (generally used PC or portable laptop computer). Alternatively, elements such as storages (functions or means) of the application distribution server 7 may be freely allocated to a plurality of computers. All or a part of the functions of the application distribution server 7 may be implemented by a server computer residing on a cloud network or a server computer residing on an on-premises network. Alternatively, the application distribution server 7 may be a communication device or a communication terminal on which software such as browser software operates.

Based on the above-described system configuration, the present embodiment provides the information management system 2 provides the user with the effect attained by the introduction of the recommended item, thereby enabling the user to easily grasp the effect of the introduction.

### Terms

In this embodiment, “migration” refers to introducing a second user device in place of a first user device. Hereinafter, a process related to migration may be referred to as a migration process. The migration process includes processing for making the application, the setting information of the function, and the like used in the first user device usable in the second user device. For example, regarding an application used in the first user device, the migration process includes introducing the application into the second user device, allocating the license of the application to the second user device, and setting, in the second user device, the setting information used in the first user device. The application, the license, and the setting information used in the first user device; and other information to be subjected to the migration process may be referred to as migration information. The first user device is an example of a user device (referred to as an old device) used before the license or the like of a specific application (item to be migrated) is migrated therefrom. The first user device is, among user devices owned by the client, a user device that is a migration source from which the item is migrated (transferred) in the migration process, and is a user device selected by the user, which will be described later. The second user device is a user device (referred to as a new device) to which the item (e.g., specific application) is migrated. The second user device is a user device that is a migration destination to which the item is migrated in the migration process, and is a user device that, for example, requests the information management apparatus 3 to perform the migration process.

“Recommendation” in the present embodiment is to recommend the introduction of an item to a client.

Examples of “recommendation” include “recommending” the introduction of an item such as an application program (hereinafter referred to as an application) to the user device 5 or the like.

In the present embodiment, the “item to be introduced” may be referred to as an “introduction target” or “installation target.” As an example, the “item to be introduced” includes an application installed on the user device 5, and action or information relating to “introduction” include a contract action or contract content by a user related to a contract of the user device 5, a purchase procedure in purchase, and investigation.

In the present embodiment, “introduction” means making an introduced item available. As an example, in a case of software such as an application, “introduction” includes making the software usable on, for example, the user device 5 or the communication terminal 4 by installation or the like, purchasing a license, and setting application functions to be provided from an external server such as the application distribution server 7. In addition, in a case of hardware or an article such as a user device, a peripheral device, or an apparatus, “introduction” includes installing the hardware or making the hardware usable, and purchasing the hardware. In a case of a service, “introduction” includes signing a contract and applying for the service.

In the present embodiment, the “user” is a person managed in association with the client ID by the information management apparatus 3. The “user” refers to, for example, a person who uses a communication terminal to view and operate various notifications transmitted from the information management apparatus 3. The “user” also refers to a person who operates the user device 5 to use a particular function, or a person who performs a transaction or procedure such as purchase or contract via a communication terminal. The “user” includes a general user and an administrative user. In this specification, the general user is a person who uses the user device 5. The administrative user is a person who manages or owns the user device 5. For example, the administrative user can introduce an item to the user device 5 based on the notification of application determination result. The user includes not only an individual but also an organization (e.g., a company), a department of an organization, a group, a team, and a group.

Further, in the present embodiment, a “client” is a person who has contracted with (subscribes to) a service provider to use a service provided by the information processing system 1. The client is managed with the client ID by the information management apparatus 3. The “client” refers to, for example, the entity to which the user and user device belong, or an account associated with the entity. The “client” also refers to, for example, an organization (e.g., a company), a department of an organization, a group, a team, and a group. However, the client may refer to an individual such as a user. In addition, the user or the user device 5 belonging to a client may be referred to as a client. One or more tenants may be associated with a client. A “tenant” includes the entity to which the user and the user device belong or an account associated with the entity. A “client” may be referred to as a tenant.

In the present embodiment, a “service” is a function provided by the information processing system 1. For example, “service” includes providing application data or an application function and recommending an item to be introduced.

### Hardware Configurations

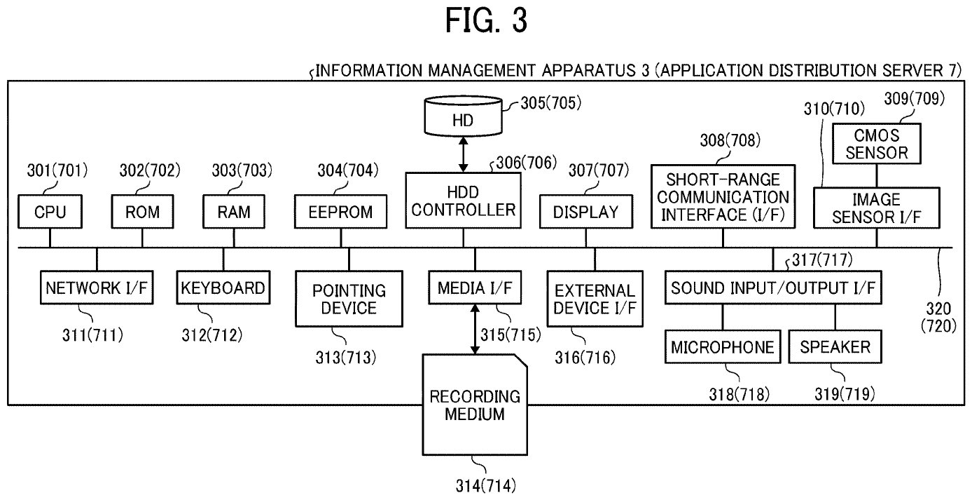

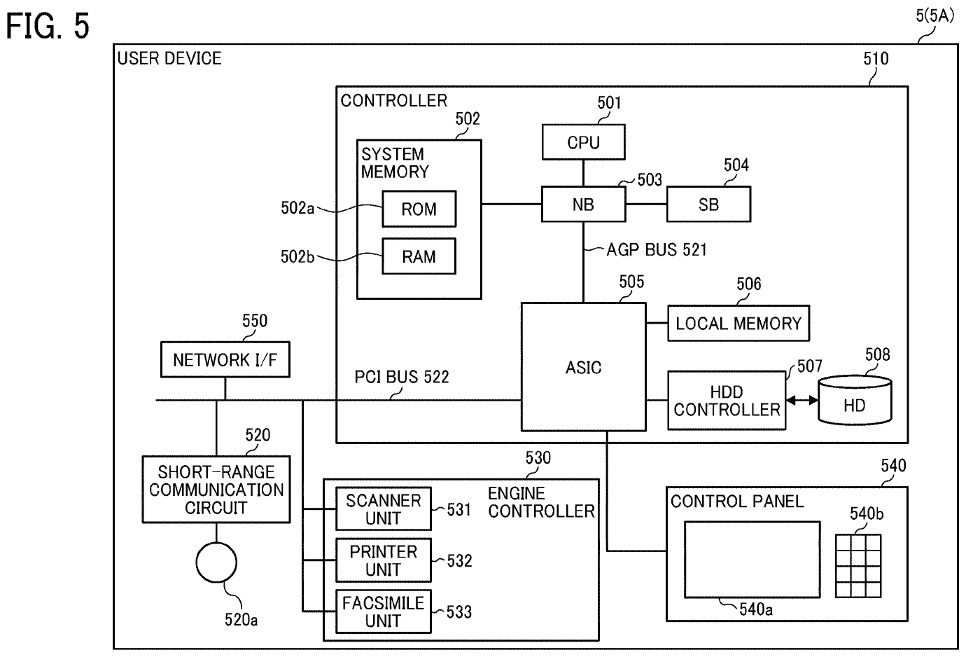

With reference to FIGS. 3 and 5, a description is given of hardware configurations of the apparatus, the device, and the communication terminal included in the information processing system according to the present embodiment. Note that certain hardware elements of the apparatus, the terminal, and the device may be added to or deleted from the hardware configurations illustrated in FIGS. 3 and 5 as appropriate.

### Hardware Configuration of Information Management Apparatus and Application Distribution Server

FIG. 3 is a block diagram illustrating a hardware configuration common to the information management apparatus 3 and the application distribution server 7. As illustrated in FIG. 3, the information management apparatus 3 is implemented by, for example, a computer and includes a central processing unit (CPU) 301, a read only memory (ROM) 302, a random access memory (RAM) 303, an electrically erasable programmable read-only memory (EEPROM) 304, an hard disk (HD) 305, a hard disk drive (HDD) controller 306, a display 307, a short-range communication interface (I/F) 308, a complementary metal oxide semiconductor (CMOS) sensor 309, and an image sensor I/F 310. The information management apparatus 3 further includes a network I/F 311, a keyboard 312, a pointing device 313, a media I/F 315, an external device I/F 316, a sound input/output I/F 317, a microphone 318, a speaker 319, and a bus line 320.

The CPU 301 controls the entire operation of the information management apparatus 3. The ROM 302 stores a control program for driving the CPU 301. The RAM 303 is used as a work area for the CPU 301. The EEPROM 304 reads or writes various data of, for example, an application under the control of the CPU 301. The HD 305 stores various data such as programs. The HDD controller 306 controls an HDD having the HD 305 to read and write various data from and to the HD 305 under the control of the CPU 301. The information management apparatus 3 may include a solid state drive (SSD) instead of the HD 305 and the HDD controller 306. The display 307 displays various kinds of information such as a cursor, a menu, a window, characters, or an image. The display 307 serves as a display or a display device according to the present embodiment. The short-range communication I/F 308 is a communication circuit for performing data communication with communication devices or communication terminals including a wireless communication interface in compliance with the near field communication (NFC), BLUETOOTH, or WIRELESS FIDELITY (WI-FI). The CMOS sensor 309 is an example of a built-in imaging device for obtaining image data or video data by capturing a subject, under the control of the CPU 301. In alternative to a CMOS sensor, an imaging device may be a charge-coupled device (CCD) sensor or the like. The image sensor I/F 310 is a circuit that controls the drive of the CMOS sensor 309.

The network I/F 311 is an interface for data communication via the communication network 100. The keyboard 312 is an input device provided with a plurality of keys for a user to input characters, numerals, or various instructions. Instead of or in addition to the keyboard 312, an input device may be implemented by a touch panel for inputting characters, numerical values, various instructions, and the like. The pointing device 313 is a kind of an input device used to select or execute various instructions, select a target for processing, or move a cursor. The media I/F 315 reads or writes (stores) data from or to a recording medium 314 such as a flash memory. The external device I/F 316 is an interface for connection with various external devices. The external device in this case is, for example, a universal serial bus (USB) memory. The sound input/output I/F 317 is a circuit for controlling input and output of sound signals between the microphone 318 and the speaker 319 under the control of the CPU 301. The microphone 318 is a built-in circuit that converts sound into electric signals. The microphone 318 acquires sound and sound waves emitted from an external speaker, etc., and acquires information using electrical signals. The speaker 319 is a built-in circuit that converts electric signals into physical vibration, thereby generating sound such as music or speech (voice). The bus line 320 is an address bus, a data bus, or the like for electrically connecting each component such as the CPU 301.

The application distribution server 7 is implemented by, for example, a computer, and includes a CPU 701, a ROM 702, a RAM 703, an EEPROM 704, an HD 705, an HDD controller 706, a display 707, a short-range communication I/F 708, a CMOS sensor 709, and an image sensor I/F 710. These hardware resources are the same as the hardware resources of the information management apparatus 3, namely, the CPU 301, the ROM 302, the RAM 303, the EEPROM 304, the HD 305, the HDD controller 306, the display 307, the short-range communication I/F 308, the CMOS sensor 309, and the image sensor I/F 310, and redundant descriptions are omitted. The application distribution server 7 further includes a network I/F 711, a keyboard 712, a pointing device 713, a media I/F 715, an external device I/F 716, a sound input/output I/F 717, a microphone 718, a speaker 719, and a bus line 720. These hardware resources are the same as the hardware resources of the information management apparatus 3, namely, the network I/F 311, the keyboard 312, the pointing device 313, the media I/F 315, the external device I/F 316, the sound input/output I/F 317, the microphone 318, the speaker 319, and the bus line 320, and redundant descriptions are omitted. The application distribution server 7 may use a generally used external server connected via the communication network 100. In this case, the hardware resource may comply with the hardware specification of the external server.

### Hardware Configuration of Communication Terminal

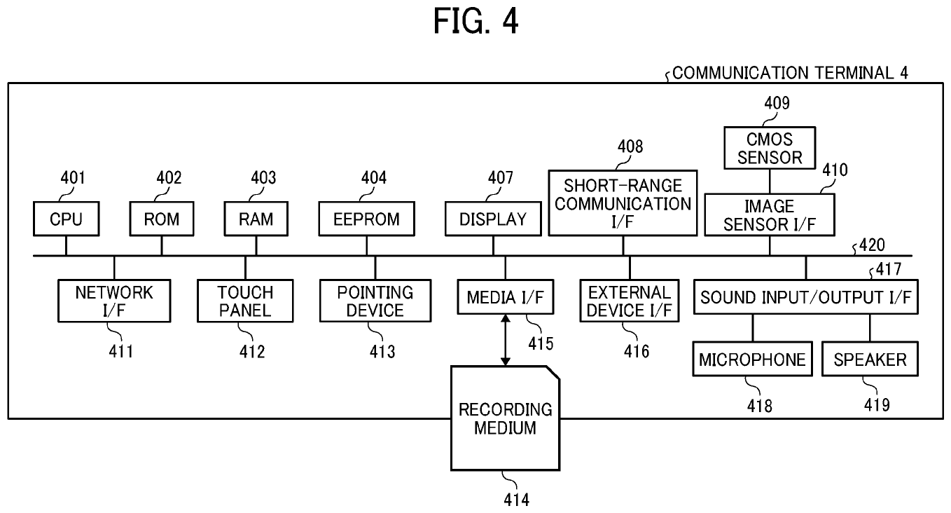

FIG. 4 is a diagram illustrating an example of a hardware configuration of the communication terminal according to the present embodiment. As illustrated in FIG. 4, the communication terminal 4 is implemented by, for example, a computer and includes a CPU 401, a ROM 402, a RAM 403, an EEPROM 404, a display 407, a short-range communication I/F 408, a CMOS sensor 409, and an image sensor I/F 410. The communication terminal 4 further includes a network I/F 411, a touch panel 412, a pointing device 413, a media I/F 415, an external device I/F 416, a sound input/output I/F 417, a microphone 418, a speaker 419, and a bus line 420.

The CPU 401 controls the entire operation of the communication terminal 4. The ROM 402 stores a program to boot the CPU 401. The RAM 403 is used as a work area for the CPU 401. The EEPROM 404 reads or writes various data such as an application under the control of the CPU 401. The display 407 displays various kinds of information such as a cursor, a menu, a window, characters, or an image. The display 407 serves as a display or a display device according to the present embodiment. The short-range communication I/F 408 is a communication circuit for performing data communication with communication devices or communication terminals including a wireless communication interface in compliance with the NFC, BLUETOOTH, or WI-FI. The CMOS sensor 409 is an example of a built-in imaging device for obtaining image data or video data by capturing a subject, under the control of the CPU 401. In alternative to a CMOS sensor, an imaging device may be a charge-coupled device (CCD) sensor or the like. The image sensor I/F 410 is a circuit that controls the drive of the CMOS sensor 409.

The network I/F 411 is an interface for performing data communication via the communication network 100. The touch panel 412 is one example of an input device that allows a user to press, click, or tap a button, or an icon, or the like on a screen of the display 407, to operate the communication terminal 4. Instead of or in addition to the touch panel 412, an input device may be implemented by a keyboard for inputting characters, numerical values, various instructions, and the like. The pointing device 413 is a kind of an input device used to select or execute various instructions, select a target for processing, or move a cursor. The media I/F 415 reads or writes (stores) data from or to a recording medium 414 such as a flash memory. The external device I/F 416 is an interface for connection with various external devices. Examples of the external devices include, but are not limited to, a USB memory. The sound input/output I/F 417 is a circuit that processes sound signal input and output between the microphone 418 and the speaker 419 under the control of the CPU 401. The microphone 418 is a built-in circuit that converts sound into electric signals. The microphone 318 acquires sound and sound waves emitted from an external speaker, etc., and acquires information using electrical signals. The speaker 419 is a built-in circuit that converts electric signals into physical vibration, thereby generating sound such as music or speech (voice). Examples of the bus line 420 include an address bus and a data bus, which electrically connect the components including the CPU 401 one another.

### Hardware Configuration of User Device

FIG. 5 is a block diagram illustrating an example of a hardware configuration of the user device. As illustrated in FIG. 5, the user device 5 is, for example, the above-mentioned MFP. In this case, the user device 5 includes hardware resources such as a controller 510, a short-range communication circuit 520, an engine controller 530, a control panel 540, and a network I/F 550.

The controller 510 includes a CPU 501 that is a main component of a computer, a system memory 502, a north bridge (NB) 503, a south bridge (SB) 504, an application specific integrated circuit (ASIC) 505, a local memory 506 as a storage unit, an HDD controller 507, and an HD 508 as another storage unit. The NB 503 and the ASIC 505 are connected through an Accelerated Graphics Port (AGP) bus 521.

The CPU 501 controls the overall operation of the user device 5. The NB 503 connects the CPU 501 with the system memory 502, the SB 504, and the AGP bus 521. The NB 503 includes a memory controller for controlling reading or writing of various data with respect to the system memory 502, a Peripheral Component Interconnect (PCI) master, and an AGP target.

The system memory 502 includes a ROM 502a that stores programs and data for implementing various functions of the controller 510. The system memory 502 further includes a RAM 502b used for loading a program and data are loaded, or loading drawing data for printing. The program stored in the RAM 502b may be provided as a file in a format installable or executable, stored on a computer-readable recording medium such as a compact disc read only memory (CD-ROM), compact disc-recordable (CD-R), or digital versatile disk (DVD).

The SB 504 is a bridge that connects the NB 503 to a PCI device and a peripheral device. The ASIC 505 is an integrated circuit (IC) dedicated to an image processing use and includes a hardware element for image processing. The ASIC 505 is a bridge that connects the AGP bus 521, a PCI bus 522, the HDD controller 507, and the local memory 506 with each other. The ASIC 505 includes a PCI target, an AGP master, an arbiter, a memory controller to control the local memory 506, a plurality of direct memory access controllers (DMACs), and a PCI unit. The arbiter arbitrates a drive timing of individual signals according to a fixed priority in the ASIC 505. The DMACs rotate image data by converting coordinates of the image data with, for example, a hardware logic. The PCI unit transfers data between a scanner unit 531 and a printer unit 532 via the PCI bus 522. The ASIC 505 may connect to a USB interface, the Institute of Electrical and Electronics Engineers 1394 (IEEE1394) interface, or both.

The local memory 506 is a memory used as a buffer (storage area) to store copy images and codes. The HD 508 is a storage (memory) that stores image data, font data used in printing, and form data. The HDD controller 507 controls an HDD having the HD 508 to read or write data to the HD 509 under the control of the CPU 501. The AGP bus 521 is a bus interface for a graphics accelerator card, which has been proposed to accelerate graphics processing. Through directly accessing the system memory 502 by high-throughput, speed of the graphics accelerator card is improved.

The short-range communication circuit 520 is provided with a short-range communication antenna 520a. The short-range communication circuit 520 is a communication circuit in compliance with the NFC, BLUETOOTH, or the like.

The engine controller 530 includes the scanner unit 531, the printer unit 532, and a facsimile unit 533. The control panel 540 includes a panel display 540a and a keypad 540b. The panel display 540a is, e.g., a touch panel that displays current settings or a selection screen and receives a user input. The keypad 540b includes, e.g., a numeric keypad and a start key. The numeric keypad receives values of parameters for image formation such as image density. The start key receives an instruction to start copying. The panel display 540a serves as a display or a display device according to the present embodiment. The controller 510 controls the entire operation of the user device 5. For example, the controller 510 controls drawing, communication, or user inputs to the control panel 540. The scanner unit 531 and the printer unit 532 have capabilities of image processing such as error diffusion and gamma (γ) conversion. The facsimile unit 533 includes an analog I/F and a modem for performing facsimile communication via an analog line (public line) with an external apparatus having a facsimile communication function, a speaker, and the like.

Note that, in response to an instruction to select a specific application using an application switch key on the control panel 540, the user device 5 sequentially selects document server, coping, printing, and facsimile transmission functions. When the document server function is selected, a document server mode is set, when the copy function is selected, a copy mode is set, when the printer function is selected, a printer mode is set, and when the facsimile mode is selected, a facsimile mode is set.

The network I/F 550 is an interface for performing data communication through the communication network 100. The short-range communication circuit 520 and the network I/F 550 are electrically connected to the ASIC 505 through the PCI bus 522.

Alternatively, the user device 5 may be a computer and have the hardware resources as illustrated in FIG. 2.

The programs may be distributed as files in an installable or executable format stored in a computer-readable recording medium or downloaded via a network. Examples of the recording medium include a CD-R, a DVD, a BLU-RAY disc, an SD card, and a USB memory. In addition, the recording medium may be provided, as a program product, to domestic users or users abroad. For example, the information management apparatus 3 executing a program according to the present disclosure, to implement an information management method according to the present disclosure.

### Functional Configuration of Information Processing System

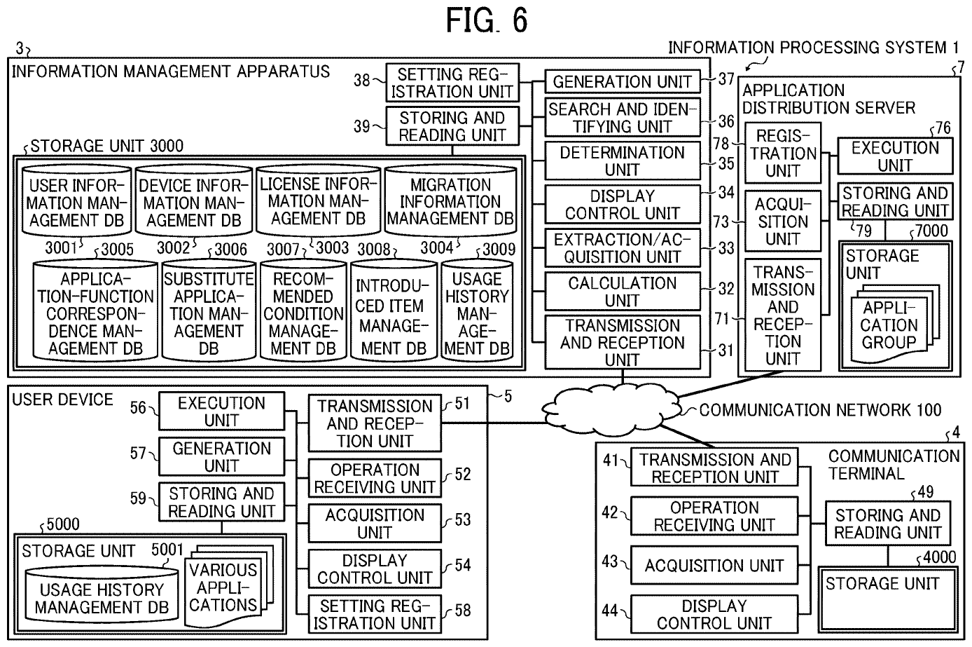

With reference to FIGS. 3 to 16, a functional configuration according to the present embodiment is described. FIG. 6 is a block diagram illustrating an example of the functional configuration of the information processing system 1. FIG. 6 illustrates elements related to processing or operation to be described below, out of apparatuses, devices, and communication terminals illustrated in FIG. 2.

### Functional Configuration of Information Management Apparatus

A description is now given of a functional configuration of the information management apparatus 3 according to the present embodiment, with reference to FIG. 3 and FIG. 6. As illustrated in FIG. 6, the information management apparatus 3 includes a transmission and reception unit 31, a calculation unit 32, an extraction/acquisition unit 33, a display control unit 34, a determination unit 35, a search and identifying unit 36, a generation unit 37, a setting registration unit 38, and a storing and reading unit 39. The functional units of the information management apparatus 3 are implemented by one or more of the hardware resources illustrated in FIG. 3 that operate in response to an instruction from the CPU 301 according to a program for the information management apparatus 3 loaded into the RAM 303 from at least one of the ROM 302, the EEPROM 304, and the HD 305. The information management apparatus 3 further includes a storage unit 3000 that is implemented by at least one of the ROM 302, the EEPROM 304, and the HD 305 illustrated in FIG. 3. The storage unit 3000 stores, for example, a communication program (communication application) for communicating with devices and terminals via the communication network 100, a browser application, and an introduced item management application for transmitting the effect of introduction of recommended items or the like to the communication terminal 4 or the user device 5.

### Functional Configuration of Information Management Apparatus

A detailed description is given of the functional configuration of the information management apparatus 3. The transmission and reception unit 31 of the information management apparatus 3 illustrated in FIG. 6 is mainly implemented by processing performed by the CPU 301 with respect to the short-range communication I/F 308 and the network I/F 311 illustrated in FIG. 3. The transmission and reception unit 31 transmits and receives various data (or information) to and from the terminals and devices via the communication network 100. In addition, when the existing user device 5 (first user device 5) is replaced with another user device 5 (second user device 5), the transmission and reception unit 31 transmits, to the second user device 5, the result of searching for a recommended application (specific application), performed based on information including a usage history of the first user device 5. The first user device 5 is the migration source (old device), and the second user device 5 is the migration destination (new device). In the present embodiment, the transmission and reception unit 31 functions as an example of at least one of a transmission unit and a reception unit.

The calculation unit 32 is mainly implemented by processing performed by the CPU 301, and executes various calculations and calculation of various values in the information management apparatus 3.

The extraction/acquisition unit 33 is mainly implemented by processing performed by the CPU 301. The extraction/acquisition unit 33 acquires migration information related to a first application used in the first user device (old device). In addition, the extraction/acquisition unit 33 acquires migration information including type information and setting information of the first application whose selection is received by the second user device. Note that the user device selects an item (e.g., application) receiving an input of the selection of the item. Accordingly, hereinafter an expression like “item whose selection is received” is simply referred to as an “item selected on the user device” or the like. The migration information at this time includes the type information and setting information of the application as function information. In the present embodiment, the extraction/acquisition unit 33 functions as an example of at least one of an extraction unit and an acquisition unit.

The display control unit 34 is mainly implemented by processing performed by CPU 301 with respect to the display 307, and controls displaying various screens and information (data) on at least one of the communication terminal 4 and the user device 5. For example, the display control unit 34 displays a display screen generated in Hyper Text Markup Language (HTML) or the like on at least one of the display 407 of the communication terminal 4 and the panel display 540a of the user device 5 via a browser.

The determination unit 35 is mainly implemented by processing performed by the CPU 301 and performs various determinations in the information management apparatus 3.

The search and identifying unit 36 is mainly implemented by the processing performed by the CPU 301. The search and identifying unit 36 determines the second application based on the acquired migration information, the function information related to the function of the first user device, and the function information related to the function of the second user device. The function implemented by the first user device is referred to as the “first function,” and the function implemented by the second user device is referred to as the “second function.” The first function and the second function are, for example, hardware included in the user device and a function provided by the hardware. Hereinafter, the information related to the first function may be referred to as first function information, and the information related to the second function may be referred to as second function information. The second application is an example of a substitute application.

The second application is an application installed in the second user device, and is, for example, an application different from the first application, installed instead of the first application. However, some or all of the functions of the second application may be the same or equivalent to those of the first application. Further, the search and identifying unit 36 determines the function of a non-migratable application that is not migratable from the first user device 5 (old device) to the second user device 5 (new device). Specifically, the search and identifying unit 36 refers to an application-function correspondence management database (DB) 3005 that stores the application name and the function of the application (application function) in association with each other, to determine functions of the application not migratable. In addition, the search and identifying unit 36 determines a function not implemented by the second user device 5 (new device), among the functions determined in the above-described determination, by referring to a device information management DB 3002 that stores the first user device identification information for identifying the first user device and the function implemented by the first user device in association with each other. In addition, referring to the application-function correspondence management DB 3005, the search and identifying unit 36 determines, as a second application (substitute application), an application corresponding to the function determined as not included in the new device. The search and identifying unit 36 performs a user authentication process based on a user authentication request transmitted from the communication terminal 8. The search and identifying unit 36 further performs a login process based on a login request transmitted from the user device 5. In the present embodiment, the search and identifying unit 36 functions as an example of an identifying unit.

The generation unit 37 is mainly implemented by the processing performed by the CPU 301. After the recommendation determination is executed, the generation unit 37 generates screen information for displaying an application determination result notification screen for recommending the item to be introduced to the client. In the present embodiment, the generation unit 37 functions as an example of a generation unit.

The setting registration unit 38 is mainly implemented by processing performed by the CPU 301. The setting registration unit 38 executes a user authentication process using the user identification information (e.g., user identifier, hereinafter also “user ID”) and the password transmitted from the communication terminal 4. The setting registration unit 38 manages the user devices 5 associated with the client ID identifying the client, the users associated with the client ID, and introduced item identification information identifying an item introduced in association with the client ID. In addition, the setting registration unit 38 registers the license information assigned to the first application used in the first user device in association with a specific application recommended for executing the second function (the function of the second device) or serving as a substitute for the first function (the function of the first device). When the first application is migratable to the second user device, the setting registration unit 38 deletes the license information assigned to the first application and registers the license information in association with the specific application. Further, the setting registration unit 38 registers the license information in association with the specific application selected on the second user device. The above-mentioned DBs (data tables) used in the above-described management will be described later. In the present embodiment, the setting registration unit 38 functions as an example of a registration unit.

The storing and reading unit 39 is mainly implemented by processing performed by the CPU 301 with respect to at least one of the ROM 302, the EEPROM 304, and the HD 305. The storing and reading unit 39 stores or reads various data (or information) in or from the storage unit 3000.

### User Information Management Table

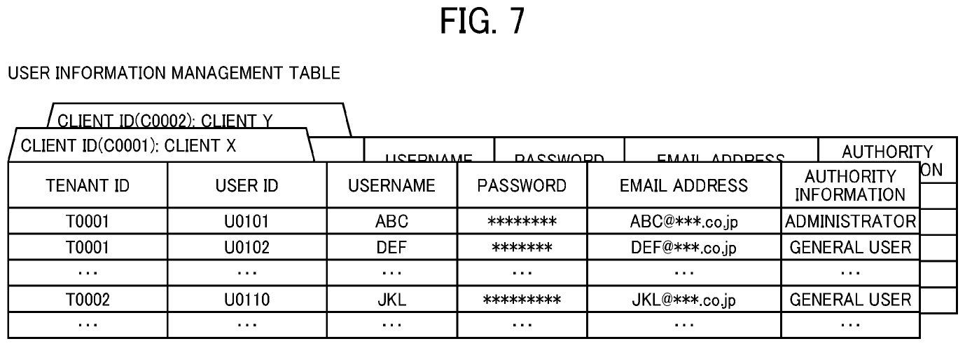

FIG. 7 is a conceptual diagram illustrating an example of a user information management table. Note that the configuration of the data table described below is an example, and the configurations of the data tables according to the embodiments are not limited thereto. The storage unit 3000 of the information management apparatus 3 includes a user information management DB 3001, for example, in the form of the user information management table as illustrated in FIG. 7. The user information management table includes tabs for classifying user IDs by client represented by at least one of the client ID and the client name. On each tab, for each user ID, items of tenant ID, user ID, username, password, email address, and authority information are stored in association with each other. The tenant ID is an example of tenant identification information. The client ID and the client name are identification information assigned to the client who uses the user device 5 in the information management system 2. For example, clients X and Y are assigned with client IDs “C0001” and “C0002,” respectively. The tenant ID is information for identifying a tenant such as a company to which the user belongs, and the content is, for example, “T0001” or “T0002.” The user ID is information for identifying a user included in (belonging to) the client, and is given as, for example, “U0001” or “U0002.” The username is a name of a user having the user ID. The password is identification information associated with user ID for logging in the information processing system 1 including the information management system 2. The user inputs the password at the time of initial activation (at the time of login) or the like. The email address is an address given to the user, for using email. The authority information is information indicating authority given to a user who uses the user device 5, and is given as, for example, “administrative user” or “general user.” For example, the user ID identifying an administrative user who manages the user device 5 is stored in association with information indicating that the role is an administrator or the user has the administrative authority. On the other hand, the user ID identifying a general user who uses the user device 5 is stored in association with information indicating that the role is a general user or the user does not have the administrative authority. The user information management DB 3001 may further store information indicating whether or not the information management apparatus 3 is to transmit the notification of application determination result for each user ID. For example, information indicating that the notification of application determination result is to be transmitted is stored in association with the user ID corresponding to the administrative user. In the present embodiment, the user information management table (user information management DB 3001) is an example of user information management unit.

### Device Information Management Table

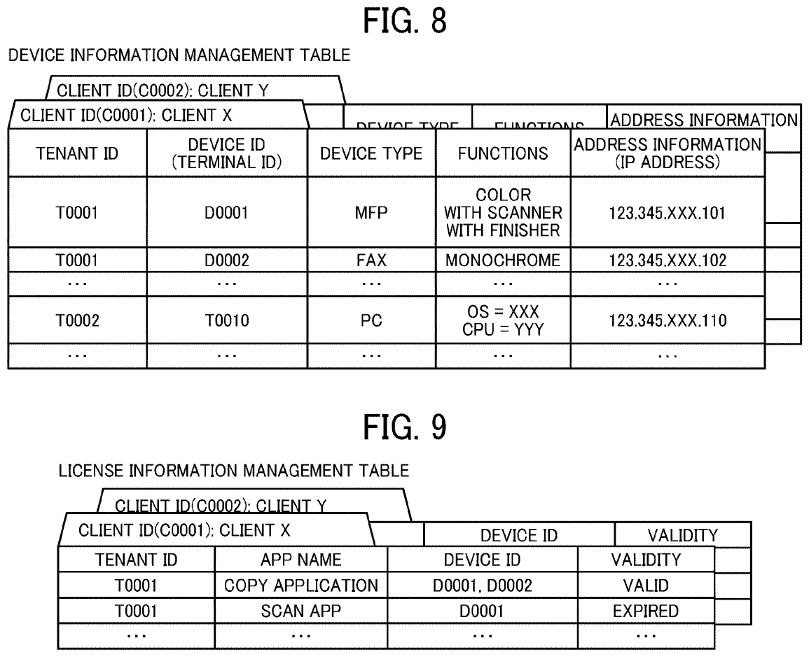

FIG. 8 is a conceptual diagram illustrating an example of a device information management table. Note that the configuration of the data table described below is an example, and the configurations of the data tables according to the embodiments are not limited thereto. The storage unit 3000 of the information management apparatus 3 includes a device information management DB 3002, for example, in the form of a device information management table as illustrated in FIG. 8. The device information management table includes tabs for classifying tenant IDs by client represented by at least one of the client ID and the client name. On each tab, for each tenant ID, items of device ID (terminal ID), device type, functions, and address information are stored in association with each other. The device ID is an example of device identification information for identifying the user device 5 (old device before migration) included in (belonging to) the client and the tenant, and is given as, for example, “D0001” or “D0002.” In the device information management table illustrated in FIG. 8, in addition to information on user device 5, information on the communication terminal 4 is managed in the item of device ID.

This information is used, for example, when the information management apparatus 3 notifies the communication terminal 4 of a recommended item to be introduced. For example, when the information management apparatus 3 notifies the communication terminal 4 of the recommendation information related to the recommended (substitute) application as the item to be introduced, the information management apparatus 3 determines the communication terminal 4 from the device ID based on the client ID as the notification target (notification destination) and transmits the notification to the destination indicated by the address information. Alternatively, the user may be determined from the user ID based on the client ID, and the notification may be transmitted to the email address. The device type is the type of the user device 5. The device types include, but not limited to, “MFP,” “scanner,” “facsimile,” “electronic whiteboard,” “projector,” “PC,” “smartphone,” and “interactive voice-controlled device (smart speaker).” The function indicates each function included in the device indicated by the device type. The address information identifies the user device 5 in the information processing system 1, and is, for example, an internet protocol (IP) address.

In the device information management DB 3002, information indicating whether or not the information management apparatus 3 transmits the notification of application determination result may be stored for each device ID. For example, the device IDs corresponding to the user device 5 and the communication terminal 4 managed by the administrative user are stored in association with information indicating that the notification of application determination result is to be transmitted.

The device information management table is used for the following purposes. For example, the device information management table is used to determine, based on the information included therein, which client ID is to be stored in association with log information received from an unmanaged device that is not managed by a first history information management table to be described later. For example, the unmanaged device is a device recently installed by a client, and log information is not collected from that device in the past. Alternatively, the device information management table is used by the information management apparatus 3 to determine a device to which device log information is to be requested. In this case, the address information is used by the information management apparatus 3 to make an inquiry to the user device 5.

In the present embodiment, the device information management table (device information management DB 3002) functions as an example of a device information management unit.

The functions stored in the device information management table are examples of the first function and the second function. The information stored in the device information management table is an example of the first function information and the second function information.

### License Information Management Table

FIG. 9 is a conceptual diagram illustrating an example of a license information management table. Note that the configuration of the data table described below is an example, and the configurations of the data tables according to the embodiments are not limited thereto. The storage unit 3000 of the information management apparatus 3 includes a license information management DB 3003, for example, in the form of the license information management table as illustrated in FIG. 9. The license information management table includes tabs for classifying tenant IDs by client represented by at least one of the client ID and the client name. On each tab, for each tenant ID, items of application name, device ID, and validity information are stored in association with each other. The application name is a name of an application to be introduced, and the content is, for example, “copy application” or “scanner application.” The application name is an example of information for identifying an application, and may be an application ID or the like. The device ID is information for identifying a device to which a license identified by the application name is assigned. For example, when a license is assigned to a plurality of devices, a plurality of device IDs may be included. The validity information indicates whether or not the application (or the license thereof) is valid, and the content is, for example, “valid” or “expired.” In the present embodiment, the license information management table (license information management DB 3003) functions as an example of a license information management unit.

The license information management DB 3003 may include, for each license, information indicating the assignable number of the license and the form of the license.

### Migration information Management Table

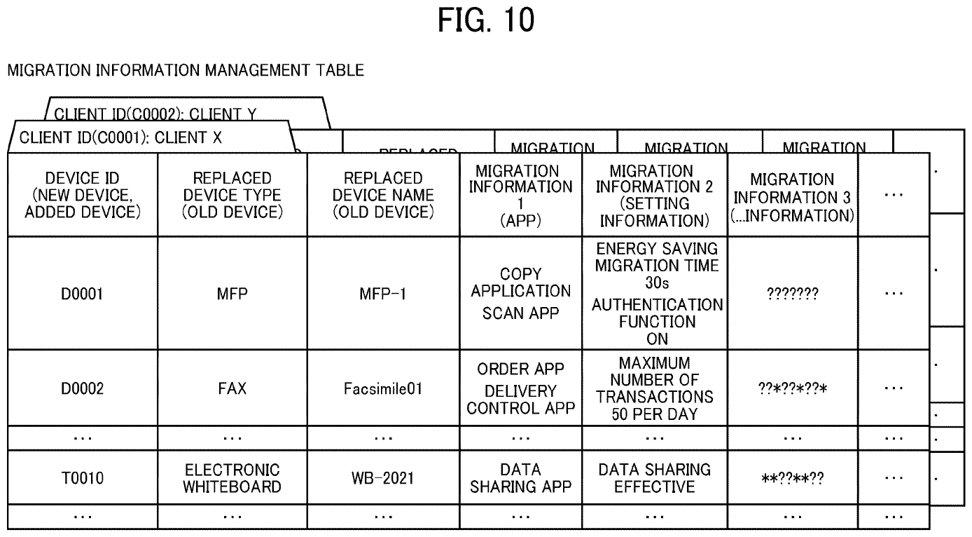

FIG. 10 is a conceptual diagram illustrating an example of a migration information management table. Note that the configuration of the data table described below is an example, and the configurations of the data tables according to the embodiments are not limited thereto. The storage unit 3000 of the information management apparatus 3 includes a migration information management DB 3004, for example, in the form of the migration information management table as illustrated in FIG. 10. The migration information management table includes tabs for classifying device IDs by client represented by at least one of the client ID and the client name. On each tab, for each device ID, items of device type, device name, migration information 1 (application), migration information 2 (setting information), and migration information 3 ( . . . information) are stored in association with each other. The migration information 1 (application) indicates the name of an application and is used for identifying one or more applications or contracts being installed in the device specified by the device ID. The migration information 1 (application) is information for identifying an application installed in the device or an application whose license is assigned to the device. For example, the content is “copy application,” “scan application,” or “order application.” The migration information 2 (setting information) is information related to various settings set in the device identified by the device ID and settings related to an application used in the device. The migration information 2 includes information on one or more settings set in the user device 5 such as an MFP. The content of the migration information 2 (setting information) is, for example, “energy saving transition time” or “maximum number of transactions.” In the present embodiment, the migration information management table (migration information management DB 3004) is an example of migration information management unit.

### Application-Function Correspondence Management Table

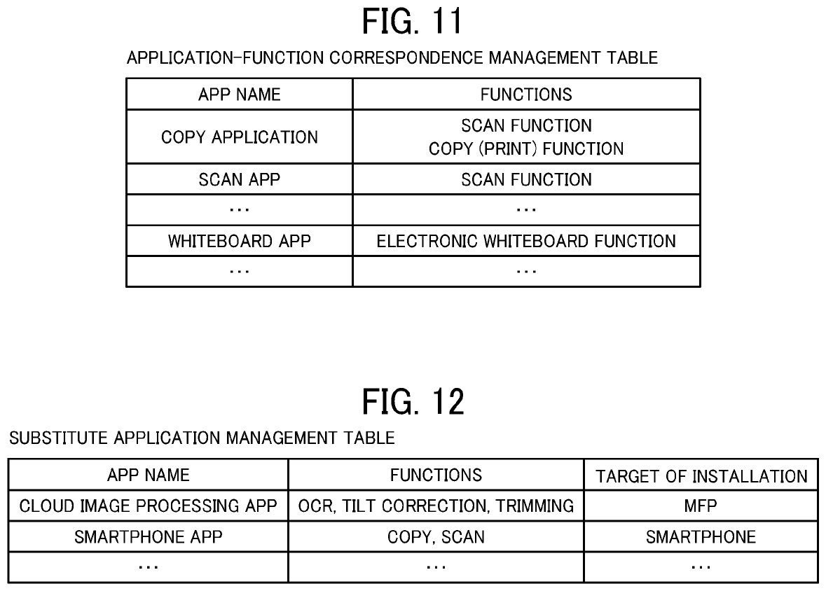

FIG. 11 is a conceptual diagram illustrating an example of an application-function correspondence management table. Note that the configuration of the data table described below is an example, and the configurations of the data tables according to the embodiments are not limited thereto. The storage unit 3000 of the information management apparatus 3 includes an application-function correspondence management DB 3005, for example, in the form of the application-function correspondence management table as illustrated in FIG. 11. In the application-function correspondence management table, items of application name and function thereof are stored in association with each other. The item “function” is information indicating a function of the application identified by the application name. In the present embodiment, the application-function correspondence management table (application-function correspondence management DB 3005) functions as an example of an application-function correspondence management unit. In the application-function correspondence management DB 3005, for example, an application developer or the like can register or edit information such as the application name and the function when the application is released.

### Substitute Application Management Table

FIG. 12 is a conceptual diagram illustrating an example of a substitute application management table. Note that the configuration of the data table described below is an example, and the configurations of the data tables according to the embodiments are not limited thereto. The storage unit 3000 of the information management apparatus 3 includes a substitute application management DB 3006, for example, in the form of the substitute application management table as illustrated in FIG. 12. In the substitute application management table, for each application name, a function of the application and a target to which the application is installable (installation destination) are stored in association with each other.

The target of installation is a device on which the substitute application is to be installed. When the target of installation is, for example, a smartphone other than a device such as an MFP, a notification of the application can suffice. In the present embodiment, the substitute application management table (substitute application management DB 3006) functions as an example of a substitute application management unit.

### Recommended Condition Management Table

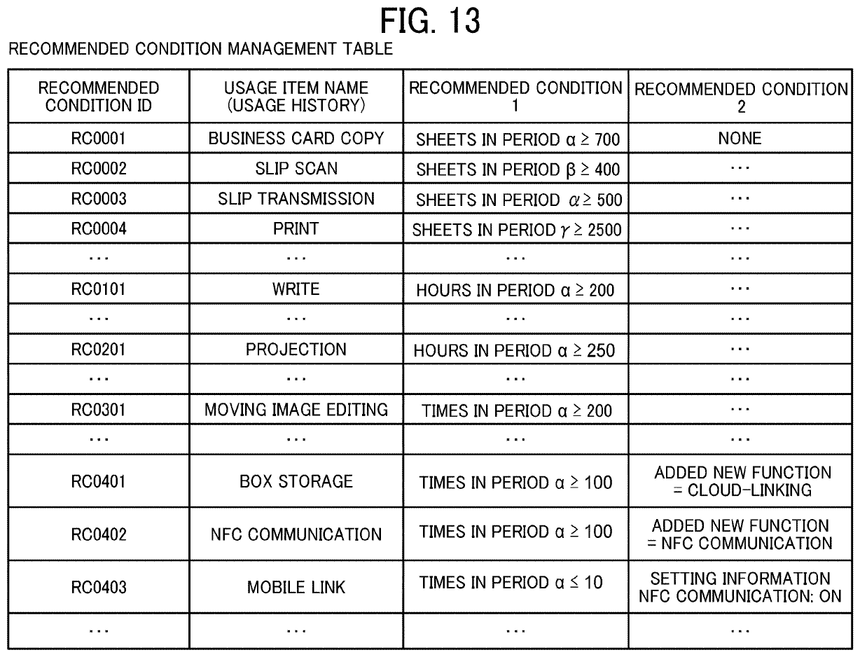

FIG. 13 is a conceptual diagram illustrating an example of a recommended condition management table. Note that the configuration of the data table described below is an example, and the configurations of the data tables according to the embodiments are not limited thereto. The storage unit 3000 of the information management apparatus 3 includes a recommended condition management DB 3007, for example, in the form of the recommended condition management table as illustrated in FIG. 13. The recommended condition management table includes, for each recommended condition ID, at least one usage item name (usage history) and at least one recommended condition. The recommended condition ID is identification information for identifying a recommended condition for introducing a recommend item such as an application, and the content is “RC0001” or “RC0002,” for example. The usage item name (usage history) indicates the name of an item used in the user device 5, and the content is “business card copy” or “slip scan,” for example. The recommendation condition 1 is a condition for recommending a recommended item, and a threshold value is given to each item given as the usage item name. For example, in a case where the usage item name is “business card copy” and the recommended condition is “sheets in period α≥700,” the recommended condition 1 is determined to be satisfied when the number of uses of the business card copy function in the period α is 700 or more. The recommendation condition 2 is a condition for recommending a recommended item and is determined in combination with the recommendation condition 1. For example, in the case of the recommended condition ID “RC0401,” information such as “added new function=cloud linking” is given. This indicates that the added new function is the cloud linking function. In this specification, the term “added new function” refers to a function included in the second user device but not in the first user device designated as the source from which items are migrated to the second user device. Further, in the case of the recommended condition ID “RC0403,” the recommended condition 2 is given as information such as “setting information=NFC communication: ON.” This indicates that the NFC communication function is set to ON in the setting of the first user device. In this context, the setting information indicates setting information set in the first user device designated as the source from which items are migrated to the second user device. When both of the recommended condition 1 and the recommended condition 2 are satisfied, it can be determined that the recommended condition identified by the recommended condition ID is satisfied.

In the present embodiment, the recommended condition management table (recommended condition management DB 3007) functions as an example of a recommended condition management unit.

### Introduced Item Management Table

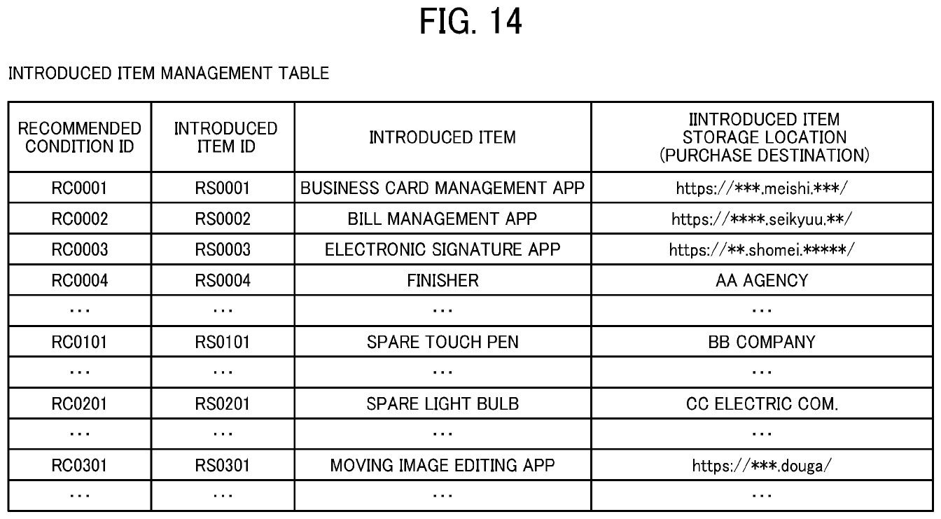

FIG. 14 is a table illustrating an example of an introduced item management table. Note that the configuration of the data table described below is an example, and the configurations of the data tables according to the embodiments are not limited thereto. The storage unit 3000 of the information management apparatus 3 includes an introduced item management DB 3008, for example, in the form of the introduced item management table as illustrated in FIG. 14. In the introduced item management table, for each recommended condition ID, items of introduced item ID, introduced item, and an introduced item storage location (purchasing source) are stored in association with each other. The introduced item ID is identification information for identifying an item to be introduced, such as an application, and the content is, for example, “RS0001” or “RD0002.” The item “introduced item” represents the name of an application or the like recommended to the user device 5, and the content is, for example, “business card management application” or “bill management app.” The introduced item storage location (purchasing source) indicates a location where the item to be introduced is stored, and the content is, for example, a uniform resource locator (URL) or a company name. In the present embodiment, the introduced item management table (introduced item management DB 3008) functions as an example of an introduced item management unit.

### Usage History Management Table

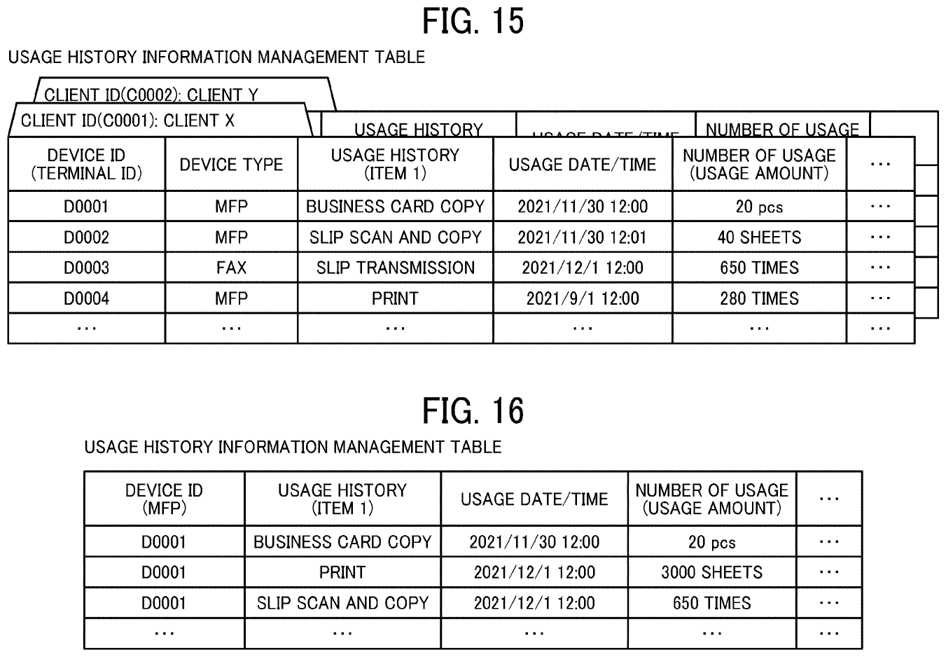

FIG. 15 is a conceptual diagram illustrating an example of a usage history management table. Note that the configuration of the data table described below is an example, and the configurations of the data tables according to the embodiments are not limited thereto. The storage unit 3000 of the information management apparatus 3 includes a usage history management DB 3009 in the form of the usage history management table as illustrated in FIG. 15. The usage history management table includes tabs for classifying device IDs by client represented by at least one of the client ID and the client name. On each tab, for each device ID, items of device type, usage history (item 1), usage date/time, and the number of usages (usage amount) are stored in association with each other. The usage history (item 1) is an example of first history information indicating a usage history related to a function of the user device 5. The content of the usage history (item 1) is, for example, “business card copy,” “slip scan and copy,” “search,” or “moving image viewing.” That is, the usage history (item 1) is information indicating a function or application executed on the user device 5. The usage date/time represents a date and time when the usage history is accumulated (that is, a date and time when a function of the application or the like is executed) or a predetermined period. The number of usages (usage amount) represents the number by which the function or application specified by the usage history (item 1) was used at the time specified by the usage date/time or in a predetermined period. The number of usages (usage amount) may be the number of times a function or an application was executed a predetermined process, or the number of times the request of execution was received. Alternatively, the number of usages (usage amount) may be the number of media, files, or data processed or the capacity thereof. Then, the information management apparatus 3 can freely set a timing at which the usage history information (the number of usages or usage amount) related to the usage history is acquired from the user device 5. The timing of acquisition may be, for example, every day, every three days, or every ten days. Accordingly, for example, when the information management apparatus 3 acquires predetermined usage history information (the number of usages or usages amount) every 10 days, the usage history information (the total number of usages or the total usages amount) for 10 days is extracted.

When the device type is MFP, conceivable contents of the usage history (item 1) managed by the usage history management table are business card copy, slip scan and print, slip transmission and reception, and print. When the device type is electronic whiteboard or interactive white board (IWB), for example, projection, writing, cooperation between sites, and sharing of results are conceivable. When the device type is projector, for example, projection and writing are conceivable. The above are examples of user devices to which the information management apparatus 3 transmits information.

When the device type is smartphone, the following are conceivable as the content of the usage history (item 1) managed by the usage history management table. Examples of the content of the usage history (item 1) include search, tethering, information sharing social networking service (SNS), call/mail, viewing of moving images, still images, and listening to music, and navigation (position and action history). In this case, the information management apparatus 3 transmits information not to the user device but to the smartphone (or PC). In the present embodiment, the usage history management table (usage history management DB 3009) functions as an example of a usage history information management unit.

### Functional Configuration of Communication Terminal

Next, a functional configuration of the communication terminal 4 is described with reference to FIGS. 4 and 6. As illustrated in FIG. 6, the communication terminal 4 includes a transmission and reception unit 41, an operation receiving unit 42, an acquisition unit 43, a display control unit 44, and a storing and reading unit 49. Each of the functional units is implemented by one or more of the hardware resources illustrated in FIG. 4 that operate in response to an instruction from the CPU 401 according to a program for the communication terminal 4 loaded into the RAM 403 from at least one of the ROM 402, the EEPROM 404, and the recording medium 414. The communication terminal 4 further includes a storage unit 4000 implemented by at least one of the ROM 402, the EEPROM 404, and the recording medium 414 illustrated in FIG. 5. The storage unit 4000 stores, for example, a communication program (communication application) for communicating with devices and terminals via the communication network 100, a browser application, and an introduced item management application for displaying the effect of introduction of recommended item or the like.

### Functional Configuration of Communication Terminal

A detailed description is given below of a functional configuration of the communication terminal 4. The transmission and reception unit 41 of the communication terminal 4 illustrated in FIG. 6 is mainly implemented by processing performed by the CPU 401 with respect to the network I/F 411 and the short-range communication I/F 408 illustrated in FIG. 4. The transmission and reception unit 41 transmits and receives various data (or information) to and from the terminals and devices via the communication network 100. In the present embodiment, the transmission and reception unit 41 functions as an example of at least one of the transmission unit and the reception unit.

The operation receiving unit 42 is mainly implemented by the CPU 401 processing signals generated by various operations received by at least one of the touch panel 412 and the pointing device 413. In the present embodiment, the operation receiving unit 42 serves as an example of a receiving unit.

The acquisition unit 43 is mainly implemented by processing performed by the CPU 401, and receives various types of information transmitted from the information management apparatus 3. For example, the acquisition unit 43 acquires the recommended information included in the notification of application determination result transmitted from the information management apparatus 3.

The display control unit 44 is mainly implemented by processing performed by CPU 401 with respect to the display 407, and controls displaying various screens and information (data) on the communication terminal 4. In addition, the display control unit 44 displays a display screen generated in HTML or the like on the display 407 of the communication terminal 4 using a browser, for example. The display control unit 44 controls the display 407 to display the acquired recommendation information.

The storing and reading unit 49 is mainly implemented by processing performed by the CPU 401 with respect to at least one of the ROM 402, the EEPROM 404, and the media I/F 415. The storing and reading unit 49 stores or reads various data (or information) in or from the storage unit 4000.

### Functional Configuration of User Device

Next, a functional configuration of the user device is described with reference to FIGS. 5 and 6. As illustrated in FIG. 6, the user device 5 includes a transmission and reception unit 51, an operation receiving unit 52, an acquisition unit 53, a display control unit 54, an execution unit 56, a generation unit 57, a setting registration unit 58, and a storing and reading unit 59. Each of the functional units is implemented by one or more of the hardware resources illustrated in FIG. 5. The one or more of the hardware resources operate in response to an instruction from the CPU 501 according to a program for the user device 5 loaded into the RAM 502b from at least one of the ROM 502a and the HD 508. In addition, the user device 5 includes a storage unit 5000 implemented by at least one of ROM 502a and HD 508 illustrated in FIG. 5.

### Functional Configuration of User Device

A detailed description is now given of the functional units of the user device 5. The transmission and reception unit 51 of the user device 5 illustrated in FIG. 6 is mainly implemented by processing performed by the CPU 501 with respect to the network I/F 550 and the short-range communication circuit 520 illustrated in FIG. 5. The transmission and reception unit 51 transmits and receives various data (or information) to and from the terminals and devices via the communication network 100. In addition, the transmission and reception unit 51 transmits, to the information management apparatus 3, first history information indicating a usage history of a function of the user device that provides the history information. In the present embodiment, the transmission and reception unit 51 functions as an example of at least one of the transmission unit and the reception unit.

The operation receiving unit 52 is mainly implemented by the CPU 501 processing signals generated by various operations received by at least one of the panel display 540a and the keypad 540b of the control panel 540. In the present embodiment, the operation receiving unit 52 serves as an example of the receiving unit.

The acquisition unit 53 is mainly implemented by processing performed by the CPU 501, and receives various types of information transmitted from the information management apparatus 3. The acquisition unit 43 acquires, for example, recommended information included in the notification of application determination result transmitted from the information management apparatus 3 and application data (a program or the like) related to various applications as examples of the item to be introduced.

The display control unit 54 is mainly implemented by processing performed by CPU 501 with respect to the panel display 540a of the control panel 540, and controls displaying various screens and information (data) on the user device 5. In addition, the display control unit 54 displays a display screen generated by HTML or the like on the control panel 540 using, for example, a browser. In the present embodiment, the MFP is an example of the user device 5, but the user device 5 is not limited thereto. Therefore, the above-described hardware resources that implement the functional units of the user device 5 can be appropriately substituted by the hardware resources of individual user device 5.

The execution unit 56 is mainly implemented by a by processing performed by CPU 501 and, for example, activates various applications, activates a print engine, executes a printing process, and executes a projecting process in the user device 5.

The generation unit 57 is mainly implemented by processing performed by the CPU 501 and generates various notification information (screen information) to be transmitted to and displayed on the user device 5.

The setting registration unit 58 is mainly implemented by processing performed by the CPU 501. The setting registration unit 58 performs tenant registration after the information management apparatus 3 executes the device registration. In the present embodiment, the setting registration unit 58 functions as an example of a registration unit.

The storing and reading unit 59 is mainly implemented by processing performed by the CPU 501 with respect to at least one of the ROM 502a and the HD 508 (via the HDD controller 507) illustrated in FIG. 3. The storing and reading unit 59 stores various data (or information) in the storage unit 5000 or reads various data (or information) from the storage unit 5000.

### Usage History Management Table

FIG. 16 is a conceptual diagram illustrating another example of the usage history management table. Note that the configuration of the data table described below is an example, and the configurations of the data tables according to the embodiments are not limited thereto. The storage unit 5000 of the user device 5 includes a usage history management DB 5001 in the form of a usage history management table as illustrated in FIG. 16. In the usage history management DB 5001, each time the user uses the function of the user device 5, items of usage history (item 1), usage date/time, and number of usages (usage amount) are registered and updated. In the usage history management table, for each device ID, items of usage history (item 1), usage date/time, and number of usages (usage amount) are stored and in association with each other. These items correspond to the items stored in the usage history management table (usage history management DB 3009) managed by the information management apparatus 3. Specifically, the content of each item of the usage history management table transmitted from the user device 5 that manages the usage history information for each device is reflected in the corresponding item of the usage history management table managed by the information management apparatus 3 (synchronization processing is performed). Each user device 5 stores the usage history management table in the storage unit 5000 thereof. In the present embodiment, the usage history management table (usage history management DB 5001) functions as another example of the usage history information management unit.

### Functional Configuration of Application Distribution Server

Next, a functional configuration of the application distribution server is described with reference to FIGS. 3 and 6. As illustrated in FIG. 7, the application distribution server 7 includes a transmission and reception unit 71, an acquisition unit 73, an execution unit 76, a registration unit 78, and a storing and reading unit 79. Each of the functional units is implemented by one or more of the hardware resources illustrated in FIG. 3 that operate in response to an instruction from the CPU 701 according to a program for the application distribution server 7 loaded into the RAM 703 from at least one of the ROM 702, the EEPROM 704, and the HD 705. Further, the application distribution server 7 includes a storage unit 7000 implemented by at least one of ROM 702, the EEPROM 704, and the HD 705 illustrated in FIG. 3. The storage unit 7000 stores, for example, a communication program (communication application) for communicating with devices and terminals via the communication network 100, a browser application, various data constructing an application group, a function execution application for executing a predetermined function requested by the user device 5, and an application to be installed in the user device 5. As described above, the application distribution server 7 may use a generally used external server connected via the communication network 100. In this case, the functional configuration may correspond to the hardware specification of the external server.

### Functional Configuration of Application Distribution Server

A detailed description is now given of a functional configuration of the application distribution server 7. The transmission and reception unit 71 of the application distribution server 7 illustrated in FIG. 8 is mainly implemented by processing performed by the CPU 701 with respect to the network I/F 711 and the short-range communication I/F 708 illustrated in FIG. 3. The transmission and reception unit 71 transmits and receives various data (or information) to and from the terminals and devices via the communication network 100. In the present embodiment, the transmission and reception unit 71 functions as an example of at least one of the transmission unit and the reception unit. For example, the transmission and reception unit 71 can receive a request for an application to be introduced from the user device 5 and distribute that application to the user device 5.

The acquisition unit 73 is mainly implemented by processing performed by the CPU 701, and receives requests of application distribution transmitted from the user device 5, requests of processing related to the user device 5 transmitted from the information management apparatus 3, and the like.

The registration unit 78 is mainly implemented by processing performed by the CPU 701, and registers various kinds of information in the application distribution server 7 in a predetermined area of the storage unit 7000 or the like.

The storing and reading unit 79 is mainly implemented by processing performed by the CPU 701 with respect to at least one of the ROM 702, the EEPROM 704, and the HD 705 (via the HDD controller 706) illustrated in FIG. 3. The storing and reading unit 79 stores various data (or information) in the storage unit 7000 or reads various data (or information) constructing an application group from the storage unit 7000.

### Various Types of Application Data

Various types of application data managed by the application distribution server 7 or an external server that communicates with the application distribution server 7 may comply with a management method or specifications for the server that manages the application data. Further, the data structure of the various application data is not particularly limited.

### Processing or Operation

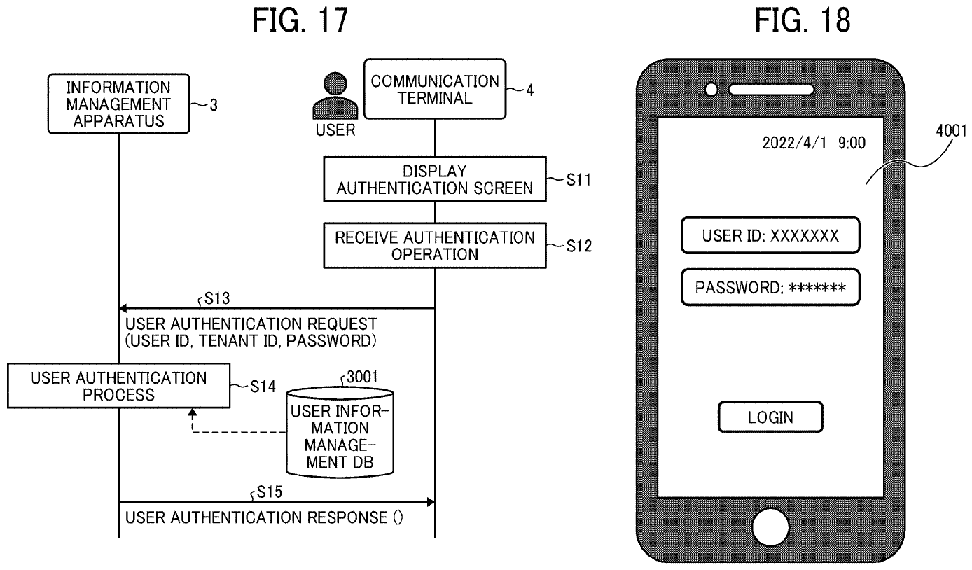

Referring now to FIGS. 17 to 36, a description is given of processes and operations in the information processing system 1.

### User Authentication

A description is given of a user authentication process in the information processing system 1. FIG. 17 is a sequence diagram illustrating an example of the user authentication process. Note that, in the present embodiment, the application use contract process performed between the communication terminal 4 or the user device 5 and the information management apparatus 3 is on the premise that the communication terminal 4 or the user device 5 has accessed the information management apparatus 3 and completed an application use contract process in advance. First, the display control unit 44 of the communication terminal 4 displays an authentication screen as illustrated in FIG. 18 on the display 407 of the communication terminal 4 (Step S11).

### Examples of Screen Display

FIG. 18 is an example of a display screen for user authentication, displayed on the communication terminal. As illustrated in FIG. 18, a login authentication screen 4001 is displayed on the display 407 of the communication terminal 4 by the display control unit 44. On the login authentication screen 4001, an input area for inputting user ID and a password, and a login button are displayed. The user can input the user ID and the password in these input areas and operate the login button.

Referring back to FIG. 17, the operation receiving unit 42 receives an authentication operation (Step S12).

Next, the transmission and reception unit 41 transmits a user authentication request to the information management apparatus 3 (Step S13). Then, the transmission and reception unit 31 of the information management apparatus 3 receives the user authentication request transmitted from the communication terminal 4. The user authentication request includes the user ID of the user of the communication terminal 4, the tenant ID for identifying the tenant to which the user belongs, and the password.

Next, the search and identifying unit 36 of the information management apparatus 3 executes a user authentication process (Step S14). To be specific, the search and identifying unit 36 searches the user information management DB 3001 (see FIG. 7), using the user ID and the password received in Step S13 as search keys, and retrieves the corresponding login information. In the user information management DB, the user ID is associated with the client ID of the client to which the user belongs in advance. Then, the search and identifying unit 36 checks whether the received user ID and the password match the retrieved user ID and the password. When the received user ID and the password match the retrieved user ID and the password, the received user ID and password are deemed to be correct.

In Step S14, the search and identifying unit 36 may be substituted by the determination unit 35 in the information management apparatus 3.

Next, the transmission and reception unit 31 transmits, to the communication terminal 4, a user authentication response as a response to the user authentication request received in Step S13 (Step S15). Accordingly, the transmission and reception unit 41 of the communication terminal 4 receives the user authentication response transmitted from the information management apparatus 3. The user authentication response includes information indicating a user authentication result (for example, authentication is successful).

Through the above-described process, a generally performed login authentication has succeeded and a session is established between the communication terminal 4 and the information management apparatus 3 so that the communication terminal 4 and the information management apparatus 3 can communicate with each other.

In the information management system 2 according to the present embodiment, for example, when steps S13 and S15 described above are executed, another device may intervene between the communication terminal 4 and the information management apparatus 3. In other words, each piece of information (or data) may be exchanged between the communication terminal 4 and the information management apparatus 3 via another device. The above-described configuration is applicable to a process that includes another processing step performed between the communication terminal 4 and the information management apparatus 3.

### Registration of User Device

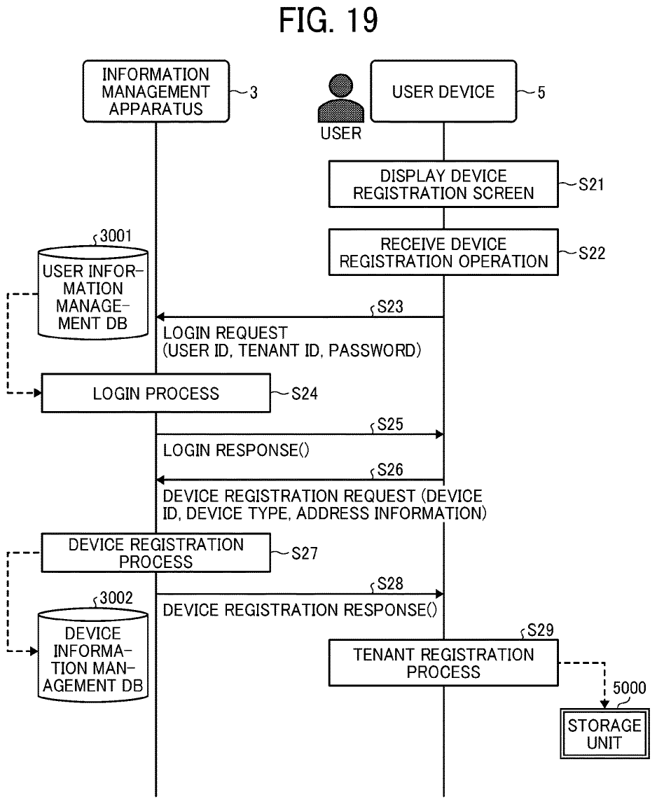

Next, a user device registration process will be described. FIG. 19 is a sequence diagram illustrating an example of the user device registration process. As illustrated in FIG. 19, the display control unit 54 of the user device 5 displays a device registration screen on the panel display 540a (Step S21). The process described below is on the assumption that a predetermined login authentication has succeeded and a session is established between the user device 5 and the information management apparatus 3 for communicating with each other.

### Examples of Screen Display

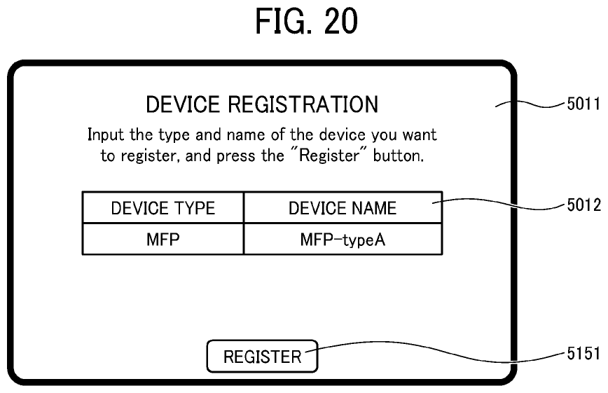

FIG. 20 is an example of a display screen for device registration, displayed on the user device. As illustrated in FIG. 20, a device registration screen 5011 is displayed on the panel display 540a of the user device 5 by the display control unit 54. On the device registration screen 5011, an input area 5012 for inputting a device type and a device name, and a register button 5151 are displayed. The user can input the device type and the device name in the input area 5012 and operate the register button 5151. The device registration process may be performed by communication between the user device 5 and the information management apparatus 3 without user input on the device registration screen illustrated in FIG. 20.

Referring back to FIG. 19, the operation receiving unit 52 receives a device registration operation (Step S22), and the transmission and reception unit 51 transmits a login request to the information management apparatus 3 (Step S23).

The transmission and reception unit 31 of the information management apparatus 3 receives the login request transmitted from the user device 5. The login request includes the user ID of the user of the user device 5, the tenant ID of the tenant to which the user belongs, and the password.

Alternatively, the tenant ID may be determined by the information management apparatus 3 and may be omitted here.

Next, the search and identifying unit 36 of the information management apparatus 3 executes a login process (Step S24). To be specific, the search and identifying unit 36 searches the user information management DB 3001 (see FIG. 7), using the user ID and the password received in Step S23 as search keys, and retrieves the corresponding login information. In the user information management DB, the user ID is associated with the client ID of the client to which the user belongs in advance. Then, the search and identifying unit 36 checks whether the received user ID and the password match the retrieved user ID and the password. When the received user ID and the password match the retrieved user ID and the password, the received user ID and password are deemed to be correct. In Step S24, the search and identifying unit 36 may be substituted by the determination unit 35 in the information management apparatus 3.

Next, the transmission and reception unit 31 transmits, to the communication terminal 4, a login response as a response to the login request received in Step S23 (Step S25).

Accordingly, the transmission and reception unit 41 of the communication terminal 4 receives the login response transmitted from the information management apparatus 3. The login response includes information indicating a login authentication result (for example, authentication is successful).

Next, the transmission and reception unit 51 of the user device 5 transmits a device registration request to the information management apparatus 3 (Step S26). The transmission and reception unit 31 of the information management apparatus 3 receives the device registration transmitted from the user device 5. The device registration request includes device ID, device type information, and address information indicating the address of the user device 5. When the input of the type or name of the device has been received in Step S21, the device registration request may include the type or name of the device. The device registration request may further include function information indicating functions implemented by the user device 5. The function information included in the device registration request is an example of the first function information and the second function information. Specifically, when the user device 5 is the first user device, the function information included in the device registration request is the first function information, and when the user device 5 is the second user device, the function information included in the device registration request is the second function information.

Next, the setting registration unit 38 of the information management apparatus 3 performs a device registration process (Step S27). To be specific, the setting registration unit 38 registers the information included in the device registration request received in Step S27 in the device information management DB 3002 (see FIG. 8) associated, in advance, with the client ID identifying the client to which the user belongs. For example, the setting registration unit 38 registers the device ID, the device type information, the address information indicating the address of the user device 5, and the function information in the device information management DB 3002 (see FIG. 8) associated, in advance, with the client ID identify the client to which the user belongs and the tenant ID. Accordingly, the information management apparatus 3 can associate the client ID with the user device 5 in the information processing system 1 (information management system 2).

Next, the transmission and reception unit 31 transmits, to the user device 5, a device registration response as a response to the device registration request received in Step S26 (Step S28). The transmission and reception unit 51 of the user device 5 receives the device registration response transmitted from the information management apparatus 3. The device registration response may include a message indicating that the device registration is completed, a registration completion flag, or the like.

Next, the setting registration unit 58 of the user device 5 performs a tenant registration process (Step S29). In this process, the setting registration unit 58 registers the tenant information related to the tenant to which the user of the user device 5 belongs or the identification information identifying the organization to which the user belongs in a predetermined area of the storage unit 5000. For example, the tenant information or the organization identification information may be included in the login response or the device registration response, and the user device 5 may store the tenant information received from the information management apparatus 3.

As described above, prior to Step S21, the user device 5 may perform a login process to log in the information management apparatus 3. In the login process, the user device 5 transmits a login request including a username, a password, and the like to the information management apparatus 3. Then, the information management apparatus 3 authenticates the user based on the information included in the login request and information in the user information management DB 3001 (see FIG. 7). Thus, the information management apparatus 3 can determine the user ID or the client ID corresponding to the user.

In addition, the process from Step S11 to Step S15 may be performed asynchronously with the process from Step S21 to Step S29, the order thereof is not limited.

In addition, in the information management system according to the present embodiment, for example, in steps S23 to S25 and steps S26 to S28 described above, another device may intervene between the information management apparatus 3 and the user device 5. In other words, each piece of information (or data) may be exchanged between the information management apparatus 3 and the user device 5 via another device. The above-described configuration is applicable to a process that includes another processing step performed between the information management apparatus 3 and the user device 5.

### Determination of Application to be Migrated

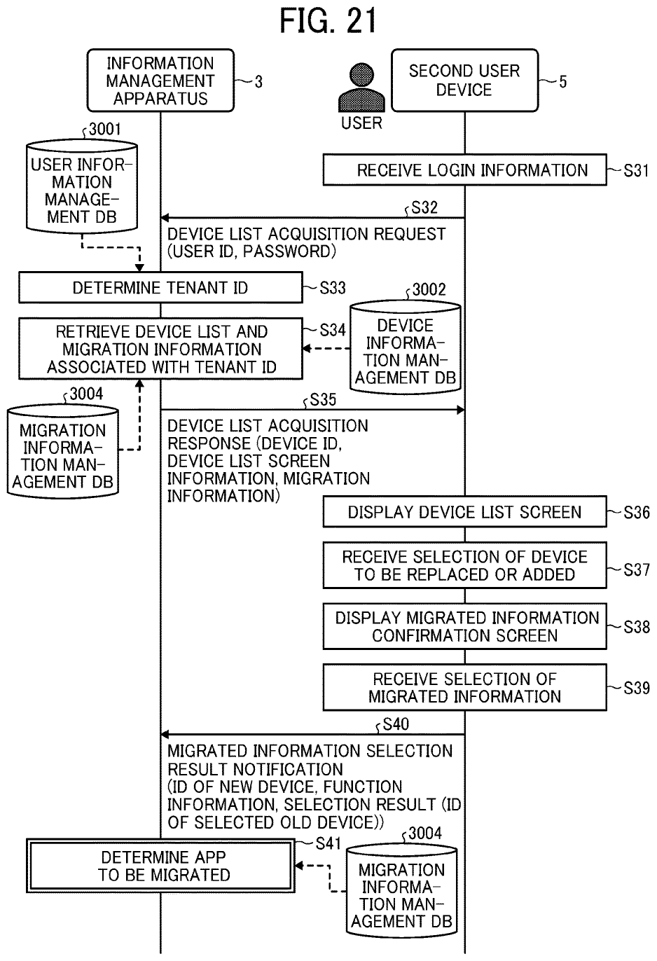

Next, determination of an application to be migrated will be described. FIG. 21 is a sequence diagram illustrating an example of a process including determining an application to be migrated. The user device 5 illustrated in FIG. 21 is a second user device. The user device 5 may start the process illustrated in FIG. 21 after completing the device registration process illustrated in FIG. 19, but the timing is not limited thereto. The timing may be before the device registration process completes. As will be described later, the user can select the first user device as a device to be replaced with the user device 5. First, the operation receiving unit 52 of the user device 5 receives login information (Step S31). As the user of the user device 5 performs a predetermined operation, the operation receiving unit 52 receives the login information.

Next, the transmission and reception unit 51 transmits a device list acquisition request to the information management apparatus 3 (Step S32). Accordingly, the transmission and reception unit 31 of the information management apparatus 3 receives the device list acquisition request transmitted from the user device 5. The device list acquisition request includes the user ID and the password. The device list acquisition request may further include the device ID of the user device 5. Alternatively, the information management apparatus 3 may periodically transmit the history information to the user device 5. In this case, the user device 5 can omit the processing in Step S31.

Subsequently, the search and identifying unit 36 of the information management apparatus 3 determines the tenant ID or the client ID (Step S33). To be specific, the search and identifying unit 36 searches the user information management DB 3001 (see FIG. 7) using the user ID and the password received in Step S32 as the search keys to determine the corresponding tenant ID or the client ID.

Next, the storing and reading unit 39 retrieves the device list and the migration information associated with the tenant ID or the customer ID (Step S34). To be specific, the storing and reading unit 39 searches the device information management DB 3002 (see FIG. 8) using the tenant ID or the client ID determined in Step S33 as a search key, to retrieve the device list information of the corresponding device. The device list information includes the device ID, the device type, the function, and the address information. Further, the storing and reading unit 39 searches the migration information management DB 3004 (see FIG. 10) using the retrieved device ID as a search key, to retrieve the corresponding migration information. The migration information includes the device type information, the device name, the migration information 1 (application), the migration information 2 (setting information), and the migration information 3 ( . . . information) . The search and identifying unit 36 may retrieve only the device list information of the devices corresponding to the device type of the user device 5. In this processing, the device type of the user device 5 may be included in the device list acquisition request, or the device type may be identified based on the device ID included in the device list acquisition request.

Next, the transmission and reception unit 31 transmits a device list acquisition response to the user device 5 as a response to the device list acquisition request received in Step S32 (Step S35). Accordingly, the transmission and reception unit 51 of the user device 5 receives the device list acquisition response transmitted from the information management apparatus 3. At this time, the device list acquisition response includes the ID of each device, device list screen information, and the migration information.

Next, the display control unit 54 of the user device 5 displays a device list screen based on the device list acquisition response (Step S36). To be specific, the display control unit 54 displays a device list screen described below on the panel display 540a.

### Examples of Screen Display

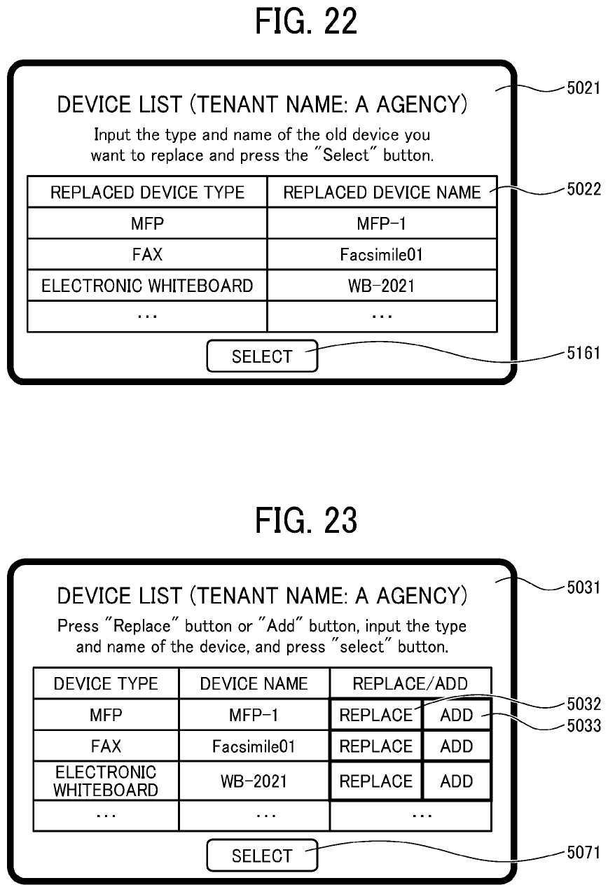

FIG. 22 is an example of a screen display for the user to select a device to be replaced or substituted with another device, displayed on the user device. The user can select a device to be replaced with the user device 5. That is, the device selected here is the first user device. As illustrated in FIG. 22, a device list screen 5021 is displayed on the panel display 540a of the user device 5 by the display control unit 54. On the device list screen 5021, each type of devices to be replaced is displayed in association the name of the replaced device.

Accordingly, the user can, for example, tap a display portion corresponding to a desired replaced device, or performing a mouse-over operation, and operate a select button 5161, thereby selecting the desired replaced device.

### Examples of Screen Display

FIG. 23 is an example of a display screen for selecting a replaced device or an added device, displayed on the user device.

The user can select a device to be replaced with the user device 5 or select a device to coexist with the added user device 5. That is, the device selected here is the first user device. As illustrated in FIG. 23, a replaced device selection screen 5031 is displayed on the panel display 540a of the user device 5 by the display control unit 54. On the replaced device selection screen 5031, for each type of devices to be replaced, the name of the replaced device, a replace button 5032, and an add button 5033 are displayed in association with each other. Accordingly, the user can operate (for example, by tapping or performs a mouse-over operation) the replace button 5032 or the add button 5033 corresponding to the desired replaced device and operate the select button 5171, thereby selecting replacement or addition. That is, by selecting the replace button 5032 or the add button 5033 displayed for each device, the user selects replacement or addition and selects the device to be replaced or added.

Referring back to FIG. 21, the operation receiving unit 52 of the user device 5 receives selection of a substituting device or an added device (Step S37). The device selected here is the first user device. To be specific, the display control unit 54 displays, on the panel display 540a, a screen for confirming information to be migrated, described below (Step S38). At this time, the user device 5 may transmit information identifying the device selected in Step S37 to the information management apparatus 3, thereby acquiring, in response, the migration information corresponding to the device.

### Examples of Screen Display

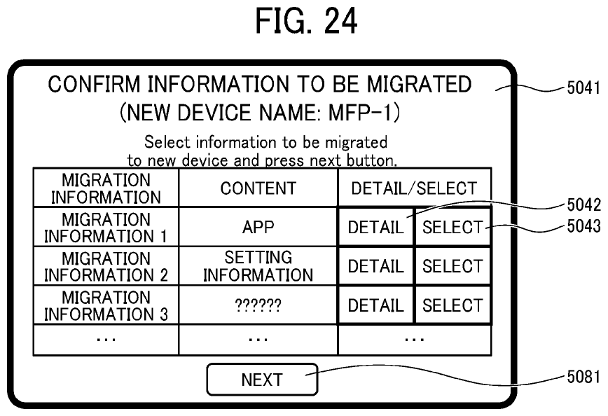

FIG. 24 is an example of a display screen for confirming information to be migrated, displayed on the user device. As illustrated in FIG. 24, a migrated information selection screen 5041 is displayed on the panel display 540a of the user device 5 by the display control unit 54. On the migrated information selection screen 5041, for each of one or more migration information as candidates to be migrated, the content, a detail button 5042, and a select button 5043 are displayed in association with each other. The user operates (for example, by tapping or performs a mouse-over operation) the detail button 5042 or the select button 5043 associated with the desired migration information. The detail button 5042 is an example of a component operated by the user to view the details of the migration information (or a graphical user interface (GUI) element for receiving user input), and the select button 5043 is a component operated for selecting information to be migrated from the first user device to the second user device. For example, when the detail button 5042 corresponding to the migration information 1 is operated, a pop-up dialog box presenting the details of an application installed on the first user device or a license assigned to the first user device is displayed. The user can view the pop-up displayed contents, operate the select button 5043 corresponding to the migration information 1, to select the migration information 1, and then operate the next button 5181. The same applies to the migration information 2 and the migration information 3. On the migrated information selection screen 5041, a plurality of migration information can be selected.

Referring back to FIG. 21, the operation receiving unit 52 of the user device 5 receives selection of the migration information (Step S39).

Next, the transmission and reception unit 51 transmits a migrated information selection result notification specifying the selected migration information to the information management apparatus 3 (Step S40). The transmission and reception unit 31 of the information management apparatus 3 receives the migrated information selection result notification transmitted from the user device 5. The migrated information selection result notification includes the device ID (new device) of the user device 5 that is the source from which the migration information selection result notification is transmitted, the functional information, and the result selected in Step S37. The result selected in Step S37 includes information identifying the first user device, information indicating replacement or addition, and information indicating which migration information is selected). However, when the function information has already been registered in Step S26, the transmission of the registered information may be omitted. The function information included in the migrated information selection result notification is an example of second function information.

Next, the search and identifying unit 36 of the information management apparatus 3 determines an application to be migrated (Step S41). Specifically, the search and identifying unit 36 determines the second application (substitute application) based on the acquired migration information, the first function information indicating the function of the first user device, and second function information indicating the function of the second user device. The determination of the migrated application and the determination of the second application (substitute application or recommended application) described below may be executed only when the migration information selected in Step S39 is the migration information 1 (application).

### Details of Migrated Application Determination

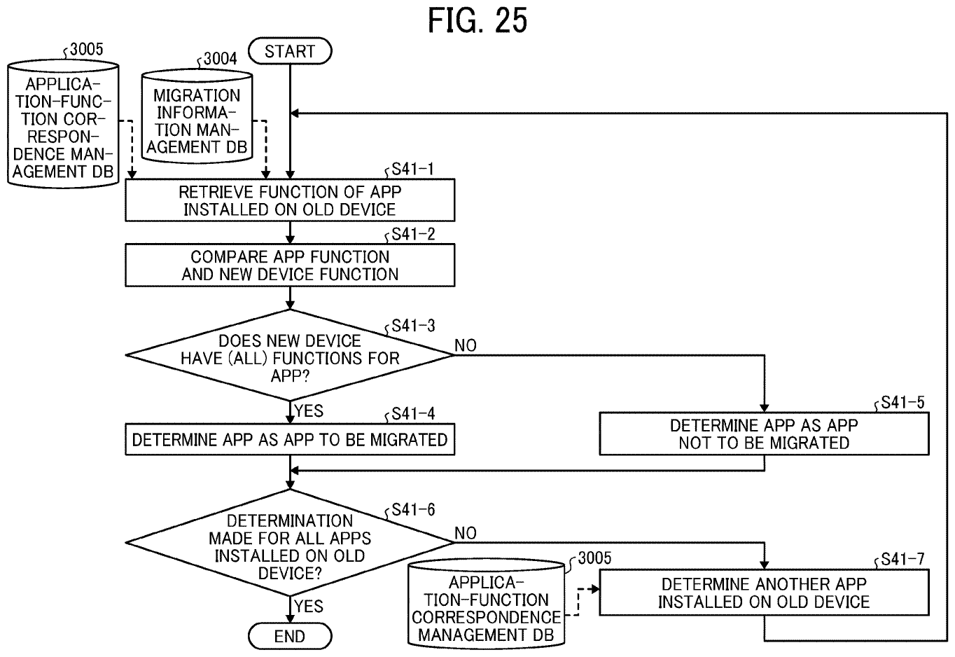

A description is given in details of the above-described determination of the migrated application in Step S41. FIG. 25 is a flowchart illustrating an example of a migrated application determination process. First, the storing and reading unit 39 of the information management apparatus 3 retrieves application information for one application installed in the first user device (old device) (Step S41-1). To be specific, the storing and reading unit 39 searches the migration information management DB 3004 (see FIG. 10) based on the result (information identifying the first user device) selected in Step S40 included in the migrated information selection result notification received in Step S37, to retrieve the corresponding migration information 1 (application). The storing and reading unit 39 further searches the application-function correspondence management DB 3005 (see FIG. 11) using the application name specified by the read migration information 1 (application) as a search key, to retrieve the corresponding functions. The application name stored in the application-function correspondence management DB 3005 is the name of an application used by the first user device (old device).

Next, the determination unit 35 compares the application function with the functions of the second user device (new device) (Step S41-2). To be specific, the determination unit 35 compares the function used by the application retrieved in Step S41-1 from the application-function correspondence management DB 3005 (see FIG. 11) with the function information of the second user device (new device). As the function information of the second user device, the information received from the second user device in Step S40 or the information registered in the device registration process in Step S27 is used.

The determination unit 35 determines whether or not the second user device (new device) has all the functions used by the application (Step S41-3). When the second user device (new device) has all the functions used by the application (Step S41-3: YES), the search and identifying unit 36 determines that the application is migratable and to be migrated (Step S41-4), and the process proceeds to Step S41-6.

On the other hand, when the second user device (new device) does not have one or more functions used by the application (Step S41-3: NO), the search and identifying unit 36 determines that the application is not migratable (Step S41-5), and the process proceeds to Step S41-6. For this determination, the application-function correspondence management DB 3005 (see FIG. 11) is searched with the application name specified by the migration information 1 (application) retrieved in step S41-1 as a search key, to retrieve the corresponding functions.

In Step S41-6, the determination unit 35 checks whether or not determination has been made for all applications installed in the first user device (old device). That is, it is determined whether or not the determination process of steps S41-1 to S41-5 has been executed for all the applications included in the migration information 1 (application). When the determination has been made for all the applications (Step S41-6: YES), the determination unit 35 ends this process.

On the other hand, if the determination has not been made for all the applications (Step S41-6: NO), the determination unit 35 transitions to Step S41-7, and the search and identifying unit 36 determines another (next) application installed on the first user device (old device) (Step S41-7). That is, another (next) application included in the migration information 1 (application) is identified.

After executing Step S41-7, the information management apparatus 3 returns to Step S41-1 and repeats the process from Step S41-1 to S41-6 until the determination is completed for all the applications.

### Substitute Application Determination

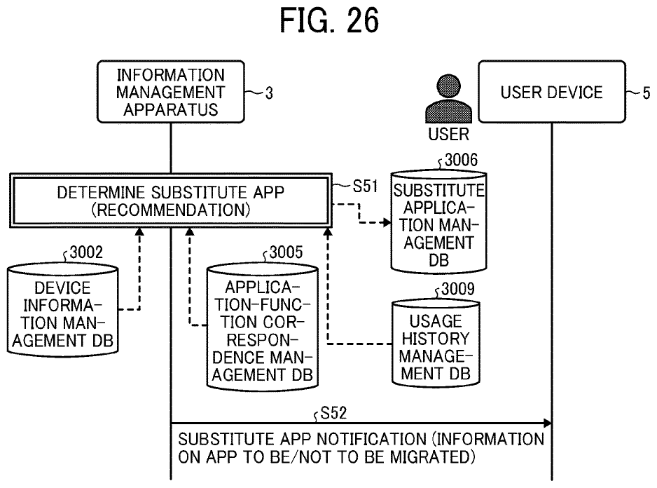

Next, a substitute application determination process executed by the information management apparatus 3 will be described. FIG. 26 is a sequence diagram illustrating an example of a process including determining a substitute application. As illustrated in FIG. 26, the search and identifying unit 36 of the information management apparatus 3 determines a substitute application (determines a recommended application) (Step S51). At this time, the information management apparatus 3 can determine the substitute application in response to receiving the migrated information selection result notification. However, the information management apparatus 3 may perform the process of determining the substitute application in response to another request from the communication terminal 4 or the user device 5, or may execute this process periodically.

### Details of Substitute Application Determination

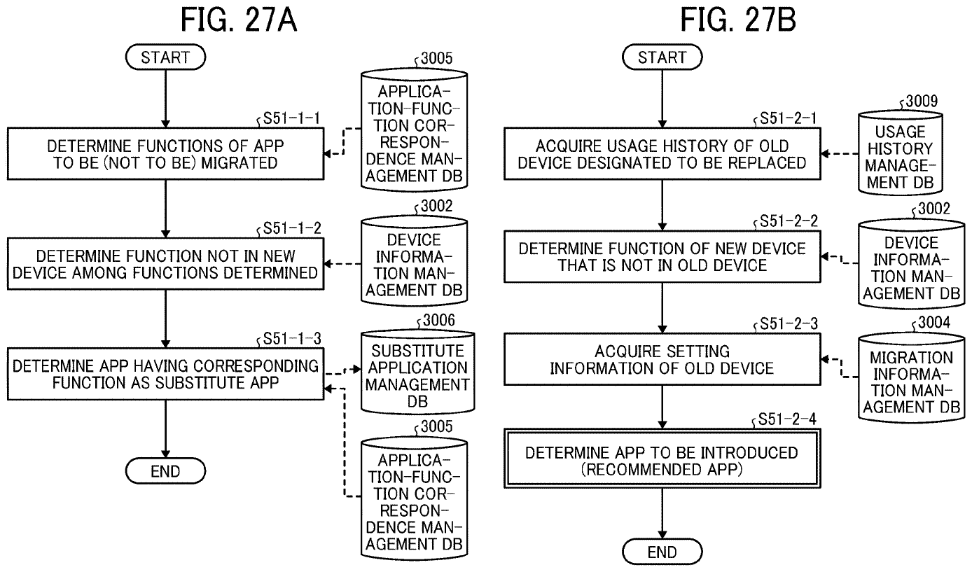

A description is given in details of the determination of the substitute application (recommended application) in Step S51 described above. FIG. 27A is a flowchart illustrating an example of details of the substitute application determination process. FIG. 27B is a flowchart illustrating an example of details of the recommended application determination process. The substitute application and the recommended application are examples of an item to be introduced. The flowchart described below is an example according to the embodiment, and the present invention is not limited thereto. In FIG. 27A, first, the search and identifying unit 36 of the information management apparatus 3 identifies the function of the non-migratable application (Step S51-1-1). To be more specific, the search and identifying unit 36 searches the application-function correspondence management DB 3005 (see FIG. 11), via the storing and reading unit 39, using the name of the migratable application identified in Step S41-5 as a search key, to determine the corresponding function.

Next, the search and identifying unit 36 determines a function that the second user device (new device) does not have among the functions determined in Step S51-1-1 (Step S51-1-2). For example, the search and identifying unit 36 searches the device information management DB 3002 (see FIG. 8), via the storing and reading unit 39, using the device ID of the second user device (new device) as a search key, thereby determining a function that the second user device (new device) does not have among the functions determined in Step S51-1-1.

Subsequently, the search and identifying unit 36 identifies an application corresponding to the function determined in Step S51-1-2 as a substitute application and exits the process (Step S51-1-3). To be more specific, the search and identifying unit 36 searches the substitute application management DB 3006 (see FIG. 12), via the storing and reading unit 39, using the function identified in Step S51-1-2 as a search key, to identify the corresponding application name. The search and identifying unit 36 determines, among the substitute applications stored in the substitute application management DB 3006, the application having at least one function corresponding to the function identified in Step S51-1-2 as the substitute application for the non-migratable application. For example, in a case where an optical character recognition (OCR) function and the scan function are identified in Step S51-1-2, the cloud image processing application and the smartphone application are determined as the substitute applications. The process from Step S51-1-1 to Step S51-1-3 described above is an example of the substitute application determination process.

### Example of Substitute Application Determination

Next, an example of the process from Step S51-1-1 to Step S51-1-3 will be described. For example, it is assumed that the first user device (old device) is a high-end MFP having an advanced image processing function and the new device is a low-end MFP having only a simple image processing function. In this case, in Step S41-5 described above, the advanced image processing application is determined to be not migratable.

In Step S51-1-1, the search and identifying unit 36 determines OCR, tilt correction, and trimming functions as functions of the advanced image processing application.

In Step S51-1-2, the determination unit 35 determines that the new device does not any of the OCR, tilt correction, and trimming functions.

In Step S51-1-3, the search and identifying unit 36 determines an application corresponding to the OCR, tilt correction, and trimming functions as the substitute application. For example, the search and identifying unit 36 determines a cloud image processing application as the substitute application. The cloud image processing application is an example of an application that provides the OCR, tilt correction, and trimming functions on the cloud by uploading scan data to the cloud. The search and identifying unit 36 may determine an application corresponding to any one of the OCR, tilt correction, and trimming functions as a substitute application.

### Other Example of Substitute Application Determination

Further, another example of the process from Step S51-1-1 to Step S51-1-3 will be described. For example, it is assumed that the first user device (old device) is an MFP having a scan function and the second user device (new device) is a printer not having the scan function. In Step S41-5 described above, the copy application is determined as an application that is not migratable.

In Step S51-1-1, the search and identifying unit 36 determines the print function and the scan function as the functions of the copy application.

In Step S51-1-2, the determination unit 35 determines that, among the print function and the scan function, the scan function is not included in the second user device (new device).

In Step S51-1-3, the search and identifying unit 36 determines that, for example, a smartphone application corresponds to the scan function. The smartphone application enables execution of printing by transmitting, to the printer, an image captured by a camera incorporated in the smartphone. As described above, the information management apparatus 3 can also propose, as a substitute application, an application of a user device different from the second user device (new device). Therefore, use of the substitute application enables the user to use the OCR function or the scan function that the second user device (new device) does not have.

### Recommended Application Determination

Next, a recommended application determination process (recommendation process) executed by the information management apparatus 3 will be described. FIG. 27B is a flowchart illustrating an example of details of the recommended application determination process. First, the extraction/acquisition unit 33 searches the usage history management DB 3009 (see FIG. 15) using, as a search key, the device ID of the first user device (old device) designated to be replaced in Step S37, to extract the usage history of the first user device from the use histories of the user devices (Step S51-2-1).

Next, the search and identifying unit 36 searches the device information management DB 3002 (see FIG. 8) using the device ID of the first user device as a search key, thereby determining a corresponding function. The search and identifying unit 36 searches the device information management DB 3002 (see FIG. 8) using the device ID of the second user device as a search key, or refers to the functional information included in the migrated information selection result notification received in Step S40, thereby determining the corresponding function. Then, the search and identifying unit 36 determines a function that is in the second user device and is not in the first user device (Step S51-2-2).

Next, the extraction/acquisition unit 33 searches the migration information management DB 3004 (see FIG. 10) using the device ID of the first user device as a search key, thereby acquiring the setting information of the corresponding first user device (old device) (Step S51-2-3).

Next, the search and identifying unit 36 determines a recommended application (Step S51-2-4).

### Details of Recommended Application Determination

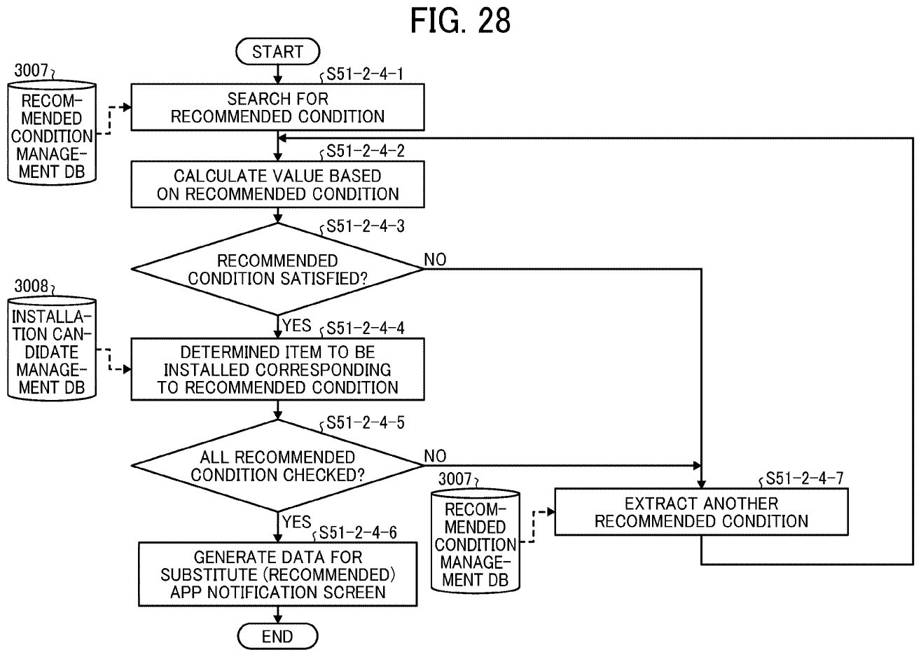

Next, a description is given in details of the recommended application determination process (recommendation process) for recommending an application as an example of the introduced item. FIG. 28 is a flowchart illustrating an example of details of the recommended application determination process. The flowchart described below is an example according to the embodiment, and the present invention is not limited thereto. First, the extraction/acquisition unit 33 extracts recommended conditions (Step S51-2-4-1). To be more specific, the extraction/acquisition unit 33 searches the recommended condition management DB 3007 (see FIG. 13) and extracts recommended conditions (recommended conditions 1, 2, . . .) associated with the recommended condition ID “RC0001.”

Next, the calculation unit 32 calculates values based on the extracted recommended conditions (Step S51-2-4-2). To be more specific, the calculation unit 32 calculates the total value of the actual measurement value (for example, the number of copied business cards and the number of purchased business card folders) corresponding to each of the usage item names stored in the recommended condition management DB 3007 (see FIG. 13). To be more specific, together with the calculation unit 32, the determination unit 35 aggregates the usage history information corresponding to the usage item name specified by the recommended condition 1 in the period specified by the recommended condition 1, among the usage history information stored in the usage history management DB 3009 (see FIG. 15). For example, the determination unit 35, together with the calculation unit 32, determines the usage history information corresponding to the usage item name “copy function (business card copy)” and having the usage date and time within the period a among the usage history information stored in the usage history management DB 3009, and calculates the total value of the number of usages (usage amount). The start or the end of the period a may be individually set according to the recommendation condition as described above, or may be determined based on the date and time when the recommendation process is executed. The calculation unit 32 determines whether to calculate the total value or the change rate based on the information included in the recommended condition. For example, in the recommended condition management DB 3007, when information indicating that the total number is used is included in the recommended conditions 1 and 2, the calculation unit 32 calculates the total value of the number of usages (usage amount) as described above. By contrast, when information indicating that the rate of change is used is included, the calculation unit 32 calculates the rate of change.

Next, the determination unit 35 determines whether or not the calculated value satisfies the recommendation condition (Step S51-2-4-3). For example, the determination unit 35 determines that the recommended condition 1 is satisfied when the total number of usages (usage amount) of the “copy function (name card copy)” in the period a calculated based on the usage history management DB 3009 is 700 sheets or more.

When the added new function is specified in the recommended condition 2 in the recommended condition management DB 3007, the determination unit 35 determines whether or not the recommended condition 2 is satisfied. For example, when the recommended condition 2 specifies “added new functions,” the determination unit 35 determines whether or not the function determined in Step S51-2-2 match the function specified by the recommended condition 2. The function determined in Step S51-2-2 is the function that is in the second user device but not in the first user device. When the recommended condition 2 specifies “setting information,” the determination unit 35 determines whether or not the setting information acquired in Step S51-2-3 includes the setting information specified by the recommended condition 2.

When it is determined that the extracted history information satisfies the recommended condition 1 and the recommended condition 2 (Step S51-2-4-3: YES), the search and identifying unit 36 extracts and determines an introduced item corresponding to the recommended conditions determined to be satisfied (Step S51-2-4-4). To be more specific, the search and identifying unit 36 searches the introduced item management DB 3008 (see FIG. 14) using the recommended condition ID corresponding to the recommended conditions determined to be satisfied in Step S51-2-4-3 as a search key, thereby extracting and determining at least one corresponding item to be introduced.

Next, the determination unit 35 determines whether or not all the recommended conditions are checked (Step S51-2-4-5).

When all the recommended conditions are checked (Step S51-2-4-5: YES), the generation unit 37 generates the screen information for displaying the application determination result notification screen and exits the process (Step S51-2-4-6).

On the other hand, when not all the recommended conditions have been checked (Step S51-2-4-5: NO), the search and identifying unit 36 extracts another recommended condition (Step S51-2-4-7), and then returns to Step S51-2-4-2. In Step S51-2-4-7, the search and identifying unit 36 searches the recommended condition management DB 3007 (see FIG. 13) and extracts another of the recommended conditions (recommended conditions 1, 2, . . . ) associated with the recommended condition ID “RC0002.” The search and identifying unit 36 extracts, for example, “slip scan” as the usage item name corresponding to the recommended condition ID “RC0002” and “sheets in period β≥400” as the recommended condition 1. The search and identifying unit 36 further extracts information stored as the recommended condition 2.

Thereafter, the above-described process from Step S51-2-4-2 to Step S51-2-4-5 is repeated.

The process from Step S51-2-4-1 to Step S51-2-4-7 described above is an example of the details of the recommended application determination process (recommendation process). In this way, the search and identifying unit 36 can check the recommended conditions by referring to the recommended conditions 1, 2, and the like stored in the recommended condition management DB 3007 (see FIG. 13) in the recommended application determination process, and determine an appropriate recommended application.

Referring back to FIG. 26, the transmission and reception unit 31 of the information management apparatus 3 transmits an application determination result notification to the user device 5 (Step S52). Accordingly, the transmission and reception unit 51 of the user device 5 receives the application determination result notification transmitted from the information management apparatus 3. At this time, the application determination result notification includes information on the migratable application or not-migratable application, and information on the determined substitute application or recommended application. When the application determination result notification includes the information on the substitute application, the transmission and reception unit 31 can switch the destination of the application determination result notification according to the target of installation onto which the substitute application is to be introduced. For example, with reference to the substitute application management DB 3006, the transmission and reception unit 31 determines whether the target of installation matches the type of the second user device. Then, only when the target of installation matches the type of the second user device, the transmission and reception unit 31 transmits the notification of application determination result to the second user device. At this time, among information on the substitute applications, only the information on the application whose target of installation matches the type of the second user device may be included in the application determination result notification. On the other hand, when the target of installation does not match the type of the second user device, the application determination result notification is transmitted to a device other than the second user device. For example, the application determination result notification can be transmitted to the email address of the administrative user of the client with reference to the user information management DB 3001. Alternatively, among information on the substitute applications, only the information on the application whose target of installation does not match the type of the second user device may be included in the application determination result notification.

### Selection of Substitute Application

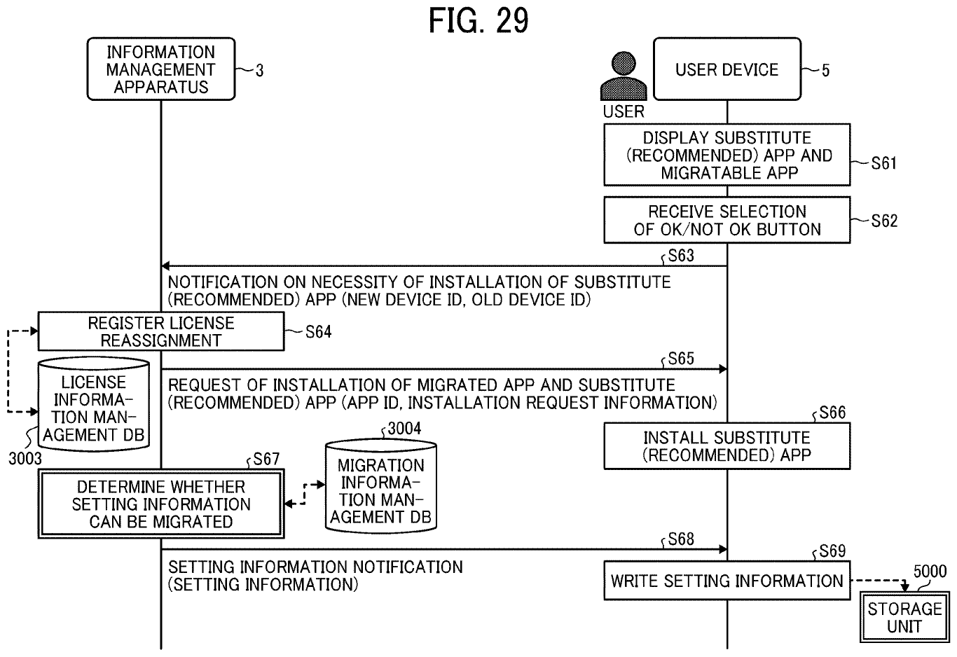

Next, a description is given of the selection of a substitute application and determination of whether setting information is migratable. FIG. 29 is a sequence diagram illustrating an example of a process of selecting a substitute application and determining whether setting information is migratable. Following Step S52 in FIG. 26, the display control unit 54 of the user device 5 displays the substitute application, the recommended application, and the migratable application on the panel display 540a of the user device 5 (Step S61). Hereinafter, the term “substitute (recommended) application” refers to at least one of the substitute application determined in Step S51-1-3 and the recommended application determined in S51-2-4.

### Examples of Screen Display

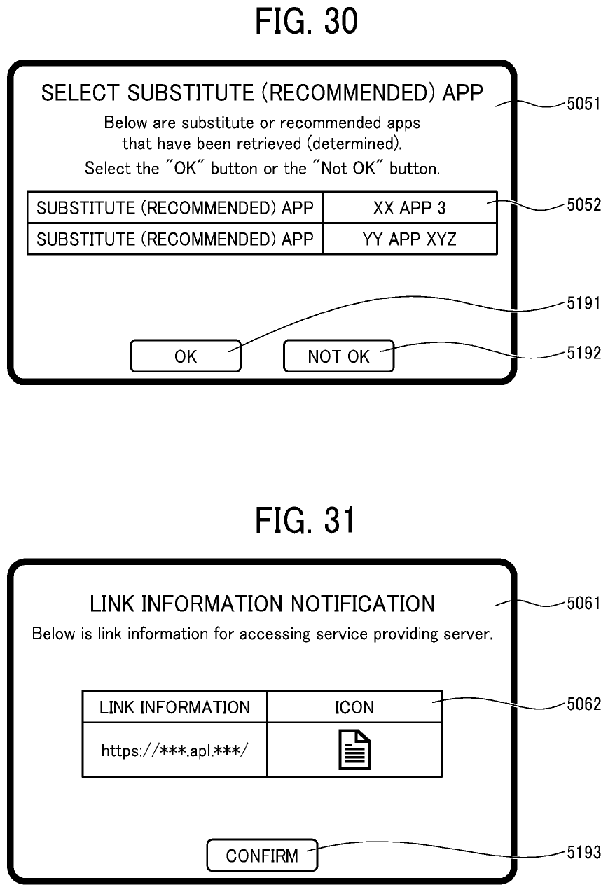

FIG. 30 is an example of a display screen for selecting a substitute (recommended) application, displayed on the user device. As illustrated in FIG. 30, a substitute application selection screen 5051 is displayed on the panel display 540a of the user device 5 by the display control unit 54. On the substitute application selection screen 5051, a corresponding application name list 5052, an OK button 5191, and a Not OK button 5192 are displayed for each substitute (recommended) application name. In this state, the user can select a substitute (recommended) application by performing an operation such as tapping on the display area of a desired application and operating the OK button 5191. The substitute application and the recommended application may be separately displayed. A select button may be provided for each application so that an application to be introduced can be selected.

### Examples of Screen Display

FIG. 31 is an example of a display screen for a link information notification, displayed on the user device. As illustrated in FIG. 31, a link information notification screen 5061 is displayed on the panel display 540a of the user device 5 by the display control unit 54. The link information notification screen 5061 includes a link information field 5062 including link information of a substitute (recommended) application and an icon image of an application corresponding to the link information. The user can access the service providing server specified by the link information by operating a confirm button 5193 for the content of the link information field 5062.

Referring back to FIG. 29, the operation receiving unit 52 receives selection of the OK button 5191 or the Not OK button 5192 by the user (Step S62). Specifically, the operation receiving unit 52 receives a user operation on the OK button 5091 (or the Not OK button 5092) described above. Before the selection of the OK button 5091 is received, the selection of one or more substitute (recommended) applications may be received.

Next, the transmission and reception unit 51 transmits a notification on the necessity of substitute (recommended) application introduction (installation) to the information management apparatus 3 (Step S63). Accordingly, the transmission and reception unit 31 of the information management apparatus 3 receives the notification on the necessity of substitute (recommended) application introduction transmitted from the user device 5. At this time, the notification on the necessity of substitute (recommended) application introduction includes information on the necessity of application introduction. However, in a case where Step S61 is not linked with, for example, Step S40 described above (for example, the communication session is discontinued), the notification on the necessity of application introduction includes the device ID of the transmission source of the notification on the necessity of application introduction, that is, the second user device (new device), and the device ID of the first user device (old device). When the selection of one or more substitute (recommended) applications is received, the notification on the necessity of application introduction includes information identifying the selected application.

Next, the setting registration unit 38 of the information management apparatus 3 performs license reassignment registration (Step S64). The setting registration unit 38 assigns the license of the application to the second user device, and cancels the license of the first user device based on the information indicating replacement or addition, included in the migrated information selection result notification received in Step S40. A detailed description is given of the case where the migrated information selection result notification includes the information indicating replacement. In this case, the setting registration unit 38 deletes the device ID of the first user device (old device) and, instead, adds the device ID of the second user device (new device) in the item “device ID” of the license information management DB 3003 (see FIG. 9) in association with the application determined to be migrated in Step S41-4, among the applications indicated by the migration information 1 in the migration information management DB 3004 (see FIG. 10). By contrast, in the case where the migrated information selection result notification includes information indicating addition, the setting registration unit 38 adds the device ID of the second user device (new device) without deleting the device ID of the first user device (old device) stored in the license information management DB 3003 (see FIG. 9) for the application determined to be migrated in Step S41-4 among the applications indicated in the migration information 1 in the migration information management DB 3004.

For the substitute (recommended) application, a new license can be assigned to the second user device. Further, the setting registration unit 38 adds the device ID of the second user device (new device) into which the recommended application is introduced to the item “device ID” in the license information management DB 3003 (see FIG. 9) for the substitute application determined in Step S51-1-3 or the recommended application determined in Step S51-2-4. However, the application determination result notification may be transmitted to an email address of the administrative user or to the communication terminal 4 owned by the administrative user. Accordingly, the administrative user can determine whether or not it is necessary to introduce the substitute (recommended) application, make a license contract for the substitute (recommended) application as necessary, and introduce the substitute (recommended) application into the second user device. When the user logging in the second user device is a general user, the information management apparatus 3 may transmit a message indicating that introduction of the substitute (recommended) application is requested to the email address of the administrative user or to the communication terminal 4 owned by the administrative user as described later, and assign the license of the substitute (recommended) application when the administrative user performs an operation for permission.

### Examples of Screen Display

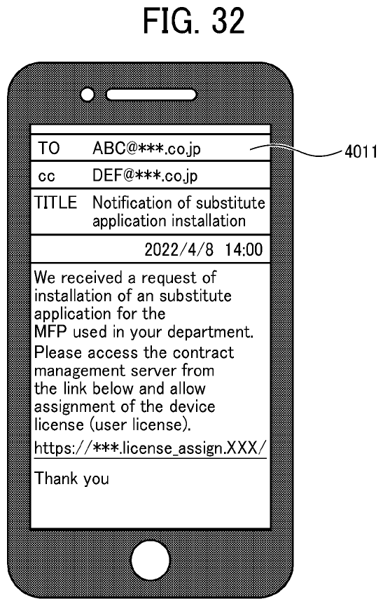

FIG. 32 is an example of a display screen for a substitute application notification, displayed on the communication terminal 4. As illustrated in FIG. 32, a substitute application notification screen 4011 is displayed on the display 407 of the communication terminal 4 by the display control unit 54. The substitute application notification screen 4011 may be, for example, a screen of an email transmitted from the information management apparatus 3 to the communication terminal 4 of the user of the new device. On the substitute application notification screen 4011 displays, for example, a message that there is a request to introduce a substitute application onto a user device used in a department to which a specific user belongs. The substitute application notification screen 4011 further displays a URL for permitting assignment of a device license to a user device onto which the substitute application is installed. Accordingly, the user is permitted to assign the device license to the user device onto which the substitute application is introduced.

Referring back to FIG. 29, the transmission and reception unit 31 transmits a request of introduction (installation) of the migrated application and the substitute (recommended) application to the user device 5 (Step S65). Accordingly, the transmission and reception unit 51 of the user device 5 receives the request of introduction of the migrated application and the substitute (recommended) application transmitted from the information management apparatus 3. At this time, the request of introduction of the migrated application and the substitute (recommended) application includes the application IDs and introduction request information.

In response to the request, the execution unit 56 of the user device 5 executes an application installation process (Step S66). For example, in the application installation process, the user device 5 accesses the application distribution server 7 and downloads the application corresponding to the application ID. Note that the information management apparatus 3 may transmit the application to the user device 5 by downloading the application from the application distribution server 7. In addition, when the application is a web application, downloading and installation of the application in the user device 5 may be omitted.

### Determination as to whether Setting Information is Migratable

Next, the determination unit 35 of the information management apparatus 3 determines whether or not the setting information is migratable (Step S67).

### Details of Determination as to whether Setting Information is Migratable

A description is given in details of the above-mentioned determination, in Step S67, of whether or not the setting information is migratable.

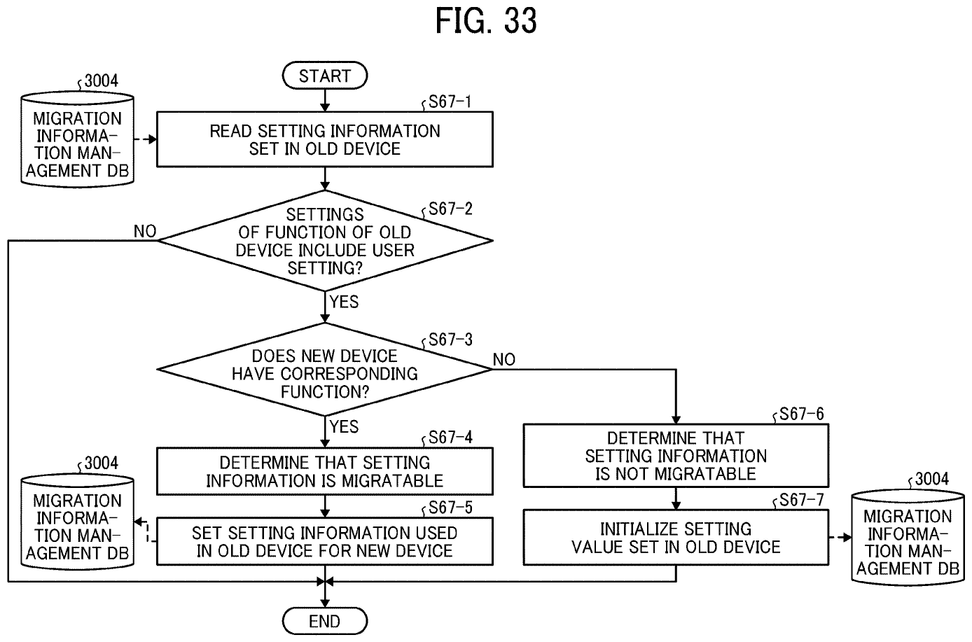

FIG. 33 is a flowchart illustrating an example of determination of whether or not setting information is migratable. The flowchart described below is an example according to the embodiment, and the present invention is not limited thereto. First, the storing and reading unit 39 of the information management apparatus 3 reads the setting information set in the first user device (old device) (Step S67-1). To be more specific, the storing and reading unit 39 searches the migration information management DB 3004 (see FIG. 10) using the device ID of the first user device (old device) received in Step S40 described above as a search key, thereby receiving the corresponding setting information. The setting information thus read is the migration information 2 stored in the migration information management DB 3004 (see FIG. 10).

Next, the determination unit 35 determines whether or not the setting information includes information set by the user (Step S67-2). When the setting information does not include the information set by the user (Step S67-2: NO), the determination unit 35 exits this process. The information set by the user in the setting information is, for example, a setting value changed from an initial value by the user, or a setting value or a condition additionally set by the user.

On the other hand, when the setting information includes the information set by the user (Step S67-2: YES), the determination unit 35 further determines whether or not the second user device (new device) has a function corresponding to the information (Step S67-3). For example, when the setting value of the energy saving transition time in the setting information is changed by the user, the determination unit 35 determines whether the second user device has a function of transitioning from the normal power mode to the energy saving state. For the functions that the second user device has, the device information management DB 3002 may be searched using the device ID of the second user device as a search key, or the information acquired from the second user device in Step S40 may be referred to. In a case where the second user device (new device) has the corresponding function (Step S67-3: YES), the determination unit 35 determines that the setting information is migratable (Step S67-4) and transitions to Step S67-5.

In Step S67-5, the setting registration unit 38 sets, for the second user device, the setting value determined to be migratable among the setting information having been set in the first user device (old device) as is, and exits this process.

On the other hand, in a case where the second user device (new device) does not have the corresponding function (Step S67-3: NO), the determination unit 35 determines that the setting information is not migratable (Step S67-6), and transitions to Step S67-7.

In Step S67-7, the setting registration unit 38 initializes the setting value set in the first user device (old device) with respect to the setting value determined to be not migratable in the setting information, and exits this process. As the initialization, the setting information may be restored to the initial value set in the first user device (old device), or may be changed to a predetermined value (for example, all 0).

Referring back to FIG. 29, the transmission and reception unit 31 of the information management apparatus 3 transmits a setting information notification to the user device 5 (Step S68). Accordingly, the transmission and reception unit 51 of the user device 5 receives the setting information notification transmitted from the information management apparatus 3. The setting information notification includes information indicating the setting value determined to be migratable in Step S67 among the setting information.

Next, the storing and reading unit 59 of the user device 5 writes the setting information in a predetermined area of the storage unit 5000 (Step S69). That is, the user device 5 reflects the received setting value in the setting information.

### Recommendation Notification to Communication Terminal

A description is given of an example of the application determination result notification transmitted to the communication terminal 4.

### Examples of Screen Display

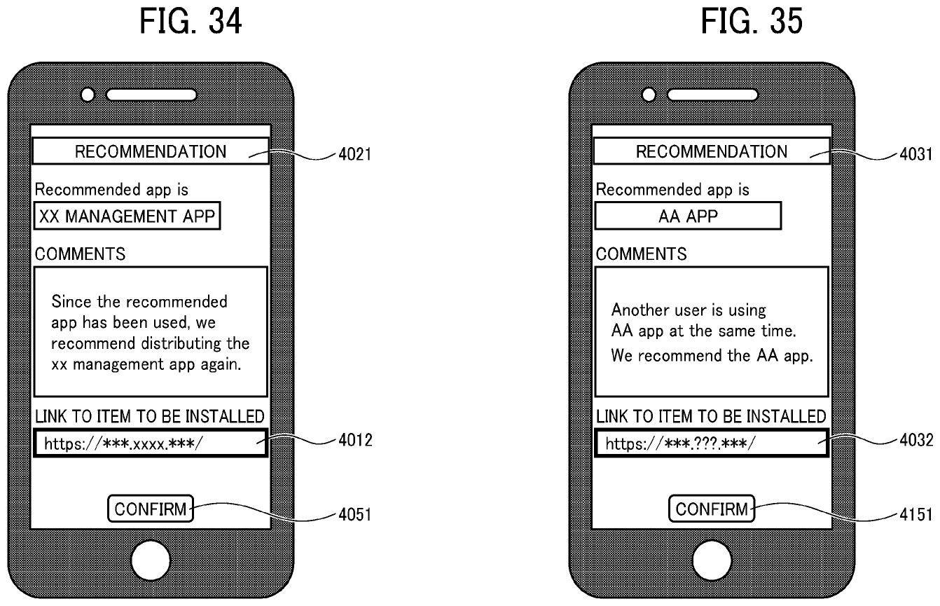

FIG. 34 is an example of a display screen for notification of application determination result, displayed on the communication terminal. As illustrated in FIG. 34, the display control unit 44 of the communication terminal 4 displays an application determination result notification screen 4021 on the display 407 of the communication terminal 4. On the application determination result notification screen 4021, an application name, a recommendation comment, and an application link 4022 corresponding to the substitute (recommended) application are displayed. The user can confirm the details of the item to be introduced by operating a confirm button 4151 after, for example, clicking the link. The recommendation comment displayed on the application determination result notification screen 4021 is intended to encourage the user to use the recommended application again.

### Examples of Screen Display

FIG. 35 is another example of the display screen for notification of application determination result, displayed on the communication terminal. As illustrated in FIG. 35, the display control unit 44 of the communication terminal 4 displays an application determination result notification screen 4031 on the display 407 of the communication terminal 4. On the application determination result notification screen 4031, an application name, a recommendation comment, and an application link 4032 corresponding to the substitute (recommended) application are displayed. This notification includes a recommendation comment indicating that another user is simultaneously using the recommended application. The user can confirm the details of the item to be introduced by operating a confirm button 4051 after, for example, clicking the link. Displaying such a comment on the application determination result notification screen 4031 can provide an effect (for example, a band wagon effect) of further encouraging the user to introduce the recommended application.

### Examples of Screen Display

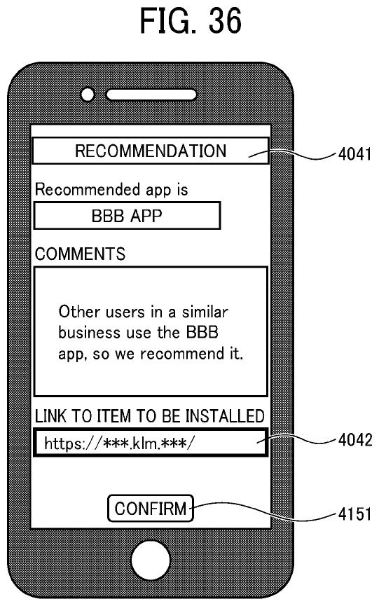

FIG. 36 is another example of the display screen for notification of application determination result, displayed on the communication terminal. As illustrated in FIG. 36, the display control unit 44 of the communication terminal 4 displays an application determination result notification screen 4041 on the display 407 of the communication terminal 4. On the application determination result notification screen 4041, an application name, a recommendation comment, and an application link 4042 corresponding to the substitute (recommended) application are displayed. The user can confirm the details of the item to be introduced by operating a confirm button 4051 after, for example, clicking the link. Similar to the display screen illustrated in FIG. 35, displaying such a comment on the application determination result notification screen 4041 can provide an effect (for example, a band wagon effect) of further encouraging the user of similar business to introduce the recommended application.

### Process using User Device of Another type

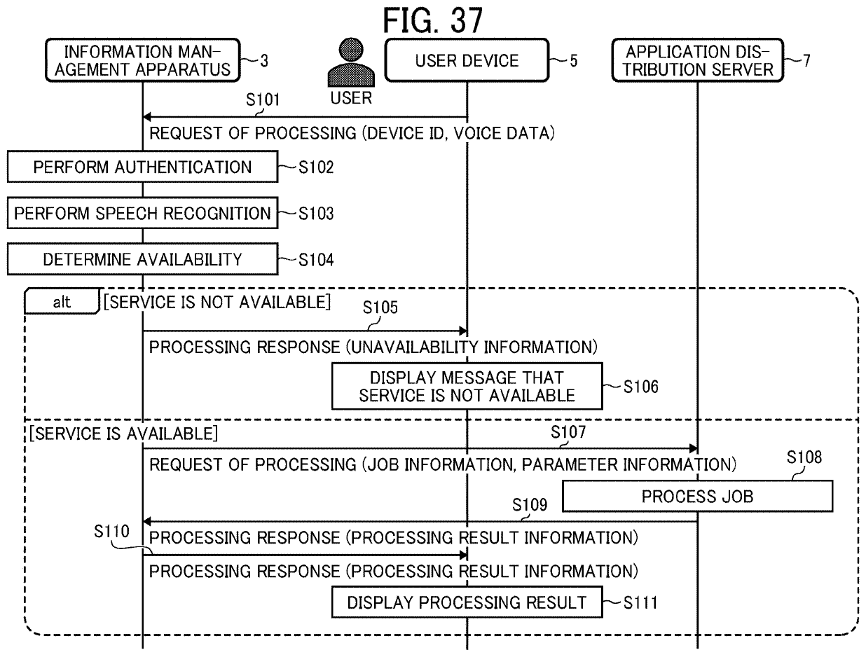

A description is given below of an example of a process using a user device of another type. FIG. 37 is a sequence diagram illustrating an example of a process using a user device of another type. Referring to FIG. 37, a description is given of a process in which the user device 5 is an interactive voice-controlled device such as a smart speaker or an artificial intelligence (AI) speaker. The “interactive voice-controlled device” is hereinafter referred to as a smart speaker. In this case, the item to be introduced is, for example, an application for the smart speaker to execute a predetermined function. Examples of the “application” include a native application that is installed to the smart speaker and uses resources of the smart speaker to provide a function, and a web application that uses resources of the smart speaker and resources of the application distribution server 7, to provide a function. Further, the “application” may refer to an extension function for extending a function provided by the application distribution server 7, a program for extending the function, and the like. Accordingly, introduction of an application includes transmitting a request to use the application from the communication terminal 4 to the application distribution server 7.

In the example of FIG. 37, first, the transmission and reception unit 51 of the smart speaker as an example of the user device 5 transmits a request of processing to the information management apparatus 3 (Step S101). Accordingly, the transmission and reception unit 31 of the information management apparatus 3 receives the request of processing transmitted from the smart speaker. The request of processing includes a device ID identifying the smart speaker and voice data input to the smart speaker.

Next, the determination unit 35 of the information management apparatus 3 performs an authentication process (Step S102). To be more specific, the determination unit 35 compares the device ID included in the voice data received in Step S101 with the device ID registered in advance in the information management apparatus 3. When the result of the comparison indicates that the matching device ID has been registered, the information management apparatus 3 determines that the authentication is successful. At this time, the determination unit 35 determines the client ID corresponding to the device ID.

Next, the determination unit 35 performs speech recognition on the voice data (Step S103), and then performs an availability determination process (Step S104). Specifically, the determination unit 35 determines an available service based on a device authority DB associated with the device ID or a client authority DB corresponding to the client ID associated with the device ID.

Alternatively, the information management apparatus 3 may determine the available service based on contract identification information and service identification information associated with the separately determined tenant ID and group identification information. The determination unit 35 of the information management apparatus 3 compares the service identification information corresponding to service information recognized from the voice data input by the user with the service identification information corresponding to a service determined as being available. As a result of the comparison, the determination unit 35 determines that the service is available when the pieces of service identification information match with each other, and determines that the service is unavailable when the pieces of service identification information do not match with each other.

When there is no available service (when the service is unavailable), the transmission and reception unit 31 of the information management apparatus 3 transmits a processing response including unavailability information indicating that the service is unavailable to the smart speaker (Step S105). As a result, the transmission and reception unit 51 of the smart speaker receives the processing response transmitted from the information management apparatus 3.

Next, the display control unit 54 of the smart speaker displays, on a display of the smart speaker, a message indicating that the service is unavailable (Step S106).

By contrast, when there is an available service (when the service is available), the transmission and reception unit 31 of the information management apparatus 3 transfers (transmits) the request of processing received from the smart speaker in Step S101 to the application distribution server 7 (Step S107). Accordingly, the transmission and reception unit 71 of the application distribution server 7 receives the request of processing transmitted from the information management apparatus 3. The request of processing includes information on a job to be processed and parameter information related to the job. Depending on the service information, the information management apparatus 3 may execute the processing based on the information on the job and the parameter information. In this case, identifying the application distribution server 7 and transmitting the request of processing can be omitted.

Next, the execution unit 76 of the application distribution server 7 executes the job (e.g., authentication) based on the received request of processing (Step S108).

Subsequently, the transmission and reception unit 71 transmits a processing response to the request of processing received in Step S107 to the information management apparatus 3 (Step S109). Accordingly, the transmission and reception unit 31 of the information management apparatus 3 receives the processing response transmitted from the application distribution server 7. The processing response includes information indicating the result of processing executed by the application distribution server 7 (processing result information).

Next, the transmission and reception unit 31 of the information management apparatus 3 transmits a processing response including the processing result information to the smart speaker (Step S110). As a result, the transmission and reception unit 51 of the smart speaker receives the processing response transmitted from the information management apparatus 3.

Next, the display control unit 54 of the smart speaker displays the processing result (Step S111). Specifically, the display control unit 54 displays the processing result information included in the received processing response on the display or outputs the processing result information as sound via the speaker. Through the process up to this point, the user using the smart speaker can cause the application distribution server 7 to execute desired processing and confirm the result displayed or output as sound.

In the information management system 1 according to the present embodiment, for example, when Steps S107 and S109 described above are executed, another device may intervene between the information management apparatus 3 and the application distribution server 7. In other words, each piece of information (or data) may be exchanged between the information management apparatus 3 and the application distribution server 7 via another device. The above-described configuration is applicable to a process that includes another processing step performed between the information management apparatus 3 and the application distribution server 7.

The above description concerns the case where the migration process is executed by operation of, for example, a button on the touch panel of the user device 5, but embodiments of the present invention is not limited thereto. For example, when the user device 5 is a smart speaker, the migration process can be voice operated.

In addition, a part or all of the process executed by the user device 5 may be executed by the communication terminal 4. In this case, for example, Steps S31, S36 to S39, and S61 to S62 may be executed by the communication terminal 4, and only Steps S66 and S69 may be executed by the user device 5. Accordingly, even the user device 5 that does not have a user interface can execute the migration process.

As described above, according to the present embodiment, the information management apparatus 3 acquires migration information related to the migration from the first user device 5 as the migration source to the second user device 5 as the migration destination, included in the received migrated information selection result notification (Step S40). Further, when the first application used in the first user device 5 (the migration source) is not migratable to the second user device 5 (the migration destination), the information management apparatus 3 determines the substitute application for the first application based on the acquired migration information, the first function information related to the first function, and the second function information related to the second function (Step S41). With this configuration, the user is provided with an appropriate application corresponding to the difference between the function of the first user device and the function of the second user device.

Furthermore, according to the present embodiment, the information management apparatus 3 registers the license information having been assigned to the first application used in the first user device in association with the specific application recommended for executing the second function or determined as a substitute for the first function (Step S64). This configuration provides, in addition to the above-described effect, an effect of appropriately performing the setting for using the application.

Each of the functions according to the described embodiment can be implemented by one or more processing circuits or circuitry. Here, the “processing circuit or circuitry” in the present disclosure includes a device programmed to execute each function by software, such as a processor implemented by an electronic circuit. The device may be, for example, a processor, an application specific integrated circuit (ASIC) designed to perform the functions described above, a digital signal processor (DSP), a field programmable gate array (FPGA), a system on a chip (SOC), a graphics processing unit (GPU), or a conventional circuit module.

In the above-described embodiment, a system that performs learning by machine learning, artificial intelligence (AI), deep learning, or the like may be used in combination with the apparatus or system described above in the process including determination such as the determination of the migrated application (Step S41), the determination of the substitute application (Step S51), and the determination of whether or not the setting information is migratable (Step S67). Furthermore, the information management system may provide a system capable of providing a message for notifying a user with an item to be introduced by using a result of learning by machine learning, AI, deep learning, or the like.

Although the information management apparatus, the information management system, the information management method, and the program according to an embodiment of the present invention have been described above, the present invention is not limited to the above-described embodiment. Within a range conceivable by those skilled in the art, another embodiment may be added, or elements may be added, changed, or omitted. Any of such aspects that provides an action and an effect of the present invention is within the scope of the present invention.

One aspect of the present disclosure concerns an information management system including a plurality of user devices and an information management apparatus that stores in a memory, for each of the plurality of user devices, information on one or more applications used therein. The plurality of user devices includes a first user device having a first function, and a second user device having a second function. The first user device includes a transmission unit to transmit, to the information management apparatus, migration information related to a migration of a first application used in the first user device to the second user device. The information management apparatus includes an acquisition unit to acquire the migration information; and an identifying unit configured to identify a second application based on the acquired migration information, first function information related to the first function of the first user device, and second function information related to the second function of the second user device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general-purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application Nos. 2022-096211, filed on Jun. 15, 2022, and 2023-048365, filed on Mar. 24, 2023, in the Japan Patent Office, the entire disclosure of which is hereby incorporated by reference herein.

### REFERENCE SIGNS LIST

1 Information processing system

2 Information management system

3 Information management apparatus

4 Communication terminal

5 User device

7 Application distribution server

31 Transmission and reception unit (example of transmission unit, example of reception unit)

33 Extraction/acquisition unit (an example of extraction unit, an example of acquisition unit)

35 Determination unit

36 Search and identifying unit (example of identifying unit)

37 Generation unit

38 Setting registration unit (example of registration unit)

407 Display

540a Panel display

1-12. (canceled)

13. An information management apparatus for storing information on an application used in a user device, the information management apparatus comprising:
acquisition circuitry configured to acquire migration information including at least one of application information of a first application used in a first user device, license information assigned to the first application, and setting information of the first application;
identifying circuitry configured to identify a second application based on the acquired migration information, first function information related to a first function of the first user device, and second function information related to a second function of a second user device; and
a transmitter configured to output information on the second application.

14. The information management apparatus according to claim 13, wherein:
the identifying circuitry is configured to refer to an application-function correspondence management circuitry to determine one or more functions provided by a non-migratable application not migratable from the first user device to the second user device, and
the application-function correspondence management circuitry stores, for each of a plurality of applications including the first application and the second application, application identification information identifying the application and one or more functions provided by the application in association with each other.

15. The information management apparatus according to claim 14, wherein:
the identifying circuitry is configured to refer to a device information management circuitry to determine a function not implemented by the second user device among the determined one or more functions provided by the non-migratable application,
the device information management circuitry stores user device identification information identifying the first user device and functions implemented by the first user device in association with each other.

16. The information management apparatus according to claim 15, wherein:
the identifying circuitry is configured to refer to the application-function correspondence management circuitry, to identify, as the second application, an application corresponding to the function determined as not implemented by the second user device.

17. The information management apparatus according to claim 13, wherein:
the second application is recommended for providing the second function or substitutes for the first function, and
the information management apparatus further comprises a registration circuitry configured to register, in a memory, license information assigned to the first application in association with the second application.

18. The information management apparatus according to claim 17, wherein:
in a case where the first application is migratable to the second user device, the registration circuitry is configured to delete the license information assigned to the first application from the memory and register the license information in association with the second application.

19. The information management apparatus according to claim 17, wherein:
the registration circuitry is configured to register the license information in association with the second application selected on the second user device.

20. The information management apparatus according to claim 13, wherein:
the migration information includes information indicating a type of the first application and setting information related to the first application selected on the second user device.

21. The information management apparatus according to claim 20, wherein:
based on information indicating whether the second user device substitutes for the first user device or is to be used in addition to the first user device, the acquisition circuitry is configured to acquire identification information identifying the first user device selected by the second user device.

22. The information management apparatus according to claim 13, wherein:
the second application is retrieved as a recommended item based on information including a usage history of the first user device, and
the transmitter is configured to transmit, to the second user device, a search result including the information on the second application.

23. An information management method, comprising:
acquiring migration information including at least one of application information of a first application used in a first user device, license information assigned to the first application, and setting information of the first application;
identifying a second application based on the acquired migration information, first function information related to a first function of the first user device, and second function information related to a second function of a second user device; and
outputting information on the second application.

24. A non-transitory computer readable recording medium storing a plurality of program codes which, when executed by one or more processors, causes an information management apparatus to perform a method, the method comprising:
acquiring migration information including at least one of application information of a first application used in a first user device, license information assigned to the first application, and setting information of the first application; and
identifying a second application based on the acquired migration information, first function information related to a first function of the first user device, and second function information related to a second function of a second user device; and
outputting information on the second application.
